(19) United States
(12) Patent Application Publication
(10) Pub. No.: US 2021/0354137 A1
(43) Pub. Date: Nov. 18, 2021

(54) MICROFLUIDIC DEVICES AND FLUIDIC LOGIC DEVICES

(71) Applicant: Facebook Technologies, LLC, Menlo Park, CA (US)

(72) Inventors: Andrew Arthur Stanley, Seattle, WA (US); Erik Samuel Roby, Seattle, WA (US)

(21) Appl. No.: 17/223,919

(22) Filed: Apr. 6, 2021

Related U.S. Application Data
(60) Provisional application No. 63/026,675, filed on May 18, 2020.
(60) Provisional application No. 63/027,222, filed on May 19, 2020.

(51) Int. Cl. B01L 3/00

(52) U.S. Cl. CPC B01L 3/502738; B01L 3/502715; B01L 2400/06; B01L 2300/023; B01L 2400/0478; B01L 3/50273

(57) ABSTRACT

Microfluidic devices may include a first inlet port for conveying a first fluid exhibiting a first pressure into the fluidic device, a second inlet port for conveying a second fluid exhibiting a second pressure into the fluidic device, an output port for conveying one of the first fluid or the second fluid out of the fluidic device, and a piston that is movable between a first position that inhibits fluid flow from the second inlet port to the output port and a second position that inhibits fluid flow from the first inlet port to the output port. Movement of the piston between the first and second positions may be determined by control pressure applied against a control gate of the piston. A flange of the piston may have an outer diameter of about 10 mm or less. Various other related methods and systems are also disclosed.

### CROSS-REFERENCE TO RELATED APPLICATIONS

This application claims the benefit of U.S. Provisional Patent Application Ser. No. 63/026,675, titled “MICROFLUIDIC VALVES, LOGIC DEVICES, AND RELATED SYSTEMS AND METHODS,” filed on May 18, 2020 and U.S. Provisional Patent Application Ser. No. 63/027,222, titled “MICROFLUIDIC VALVES, LOGIC DEVICES, AND RELATED SYSTEMS AND METHODS,” filed on May 19, 2020, the entire disclosure of each of which is incorporated herein by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is an illustration of an example piston of a fluidic valve biased in a down position, according to at least one embodiment of the present disclosure.

FIG. 2 is an illustration of an example piston of a fluidic valve biased in an up position, according to at least one embodiment of the present disclosure.

FIG. 3 is an illustration of an example piston of a fluidic valve biased in a central position, according to at least one embodiment of the present disclosure.

FIG. 4 is an illustration of an example piston of a fluidic valve configured with a high gain gate, according to at least one embodiment of the present disclosure.

FIG. 5 is a cross-sectional view of an example fluidic valve, according to at least one embodiment of the present disclosure.

FIG. 6A is a plan view of example pistons disposed in a fluidic valve assembly, according to at least one embodiment of the present disclosure.

FIG. 6B is a semi-transparent perspective view of a fluidic valve assembly that includes multiple pistons, according to at least one embodiment of the present disclosure.

FIG. 7 is a cross-sectional view of a piezoelectric fluidic valve, according to at least one embodiment of the present disclosure.

FIGS. 8A and 8B are cross-sectional views of an example fluidic valve buffer, according to at least one embodiment of the present disclosure.

FIGS. 9A-9C are cross-sectional views of an example fluidic valve inverter and a corresponding truth table, according to at least one embodiment of the present disclosure.

FIGS. 10A-10E are cross-sectional views of an example OR fluidic logic-gate device and a corresponding truth table, according to at least one embodiment of the present disclosure.

FIGS. 11A-11E are cross-sectional views of an example AND fluidic logic-gate device and a corresponding truth table, according to at least one embodiment of the present disclosure.

FIG. 12 is a cross-sectional view of an example NOR fluidic logic-gate device and a corresponding truth table, according to at least one embodiment of the present disclosure.

FIG. 13 is a cross-sectional view of an example NAND fluidic logic-gate device and a corresponding truth table, according to at least one embodiment of the present disclosure.

FIG. 14 is a cross-sectional view of an example XOR fluidic logic-gate device and a corresponding truth table, according to at least one embodiment of the present disclosure.

FIG. 15 is a cross-sectional view of an example XNOR fluidic logic-gate device and a corresponding truth table, according to at least one embodiment of the present disclosure.

FIG. 16 is a cross-sectional view of an example demultiplexer fluidic logic-gate device, according to at least one embodiment of the present disclosure.

FIG. 17 is a logic diagram and truth table for a fluidic full adder device and a corresponding truth table, according to at least one embodiment of the present disclosure.

FIG. 18 is a cross-sectional view of an example fluidic full adder device and corresponding truth table, according to at least one embodiment of the present disclosure.

FIG. 19 is a cross-sectional view of an alternative configuration of a fluidic valve, according to at least one embodiment of the present disclosure.

FIG. 20 is a cross-sectional view of an alternative configuration of a fluidic valve buffer in two states and corresponding truth table, according to at least one embodiment of the present disclosure.

FIG. 21 is a cross-sectional view of an alternative configuration of a fluidic valve inverter in two states and corresponding truth table, according to at least one embodiment of the present disclosure.

FIG. 22 is a cross-sectional view of an example fluidic row column buffered latch decode device, according to at least one embodiment of the present disclosure.

FIG. 23 is a cross-sectional view of an example fluidic row column demultiplexer device, according to at least one embodiment of the present disclosure.

FIG. 24 is a cross-sectional view of an example fluidic row column inverted demultiplexer device, according to at least one embodiment of the present disclosure.

FIG. 25 is a cross-sectional view of an example fluidic row column demultiplexer hybrid inverted device, according to at least one embodiment of the present disclosure.

FIG. 26A is a schematic illustration of a linearized variable pressure regulator device, according to at least one embodiment of the present disclosure. FIGS. 26B and 26C are respectively charts of simulated and experimental data of a linearized variable pressure regulator device, according to at least one embodiment of the present disclosure.

FIG. 27 illustrates variable diameter orifices of a linearized variable pressure regulator device, according to at least one embodiment of the present disclosure.

FIG. 28 is a cross-sectional view of an example push-pull fluidic amplifier device, according to at least one embodiment of the present disclosure.

FIG. 29 is a perspective view of a physical implementation of a fluidic full adder device, according to at least one embodiment of the present disclosure.

FIG. 30 is a block diagram of a microfluidic control system, according to at least one embodiment of the present disclosure.

FIG. 31 is a block diagram of a microfluidic control system, according to at least one additional embodiment of the present disclosure

FIG. 32 is an illustration of exemplary augmented-reality glasses that may be used in connection with embodiments of this disclosure.

FIG. 33 is an illustration of an exemplary virtual-reality headset that may be used in connection with embodiments of this disclosure.

FIG. 34 is an illustration of exemplary haptic devices that may be used in connection with embodiments of this disclosure.

FIG. 35 is an illustration of an exemplary virtual-reality environment according to embodiments of this disclosure.

FIG. 36 is an illustration of an exemplary augmented-reality environment according to embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to microfluidic valves, systems, and related methods. Microfluidic systems may be small mechanical systems that control the pressure and/or flow of fluids. Microfluidic systems may be used in many different fields, such as artificial reality, biomedical, chemical, genetic, biochemical, pharmaceutical, haptics, and other fields. A microfluidic valve may be a basic component of a microfluidic system and may be used for stopping, starting, or otherwise controlling pressure and/or flow of a fluid in a microfluidic system.

As will be explained in greater detail below, embodiments of the instant disclosure may include fluidic valves and systems that may be actuated via fluid pressure, with a piezoelectric material, or with other mechanisms, for example. Related methods of controlling flow of a fluid and of fabricating fluidic systems are also disclosed. The present disclosure may include haptic fluidic systems that involve the control (e.g., stopping, starting, alternating, restricting, increasing, etc.) of fluid flow through a fluid channel and/or a fluid chamber. The control of fluid flow may be accomplished with one or more fluidic valves.

Features from any of the embodiments described herein may be used in combination with one another in accordance with the general principles described herein. These and other embodiments, features, and advantages will be more fully understood upon reading the following detailed description in conjunction with the accompanying drawings and claims.

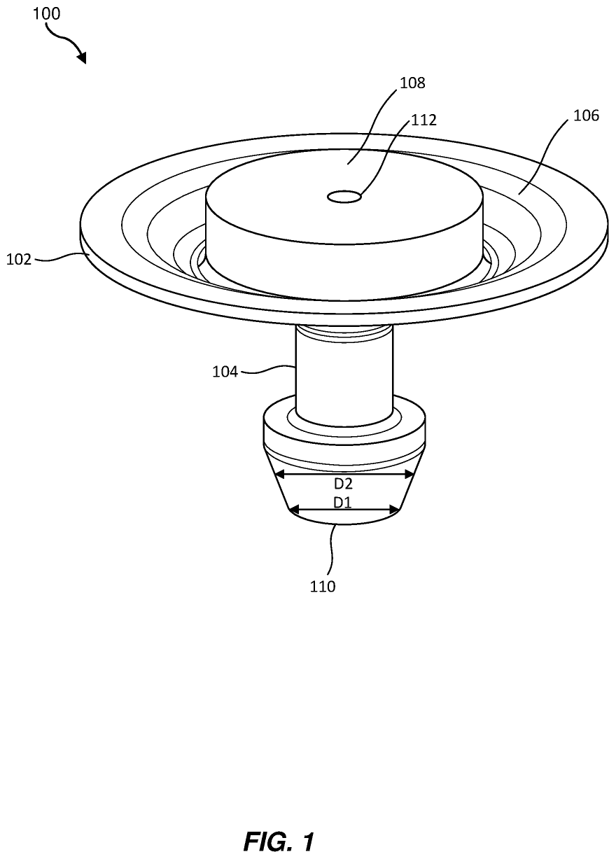

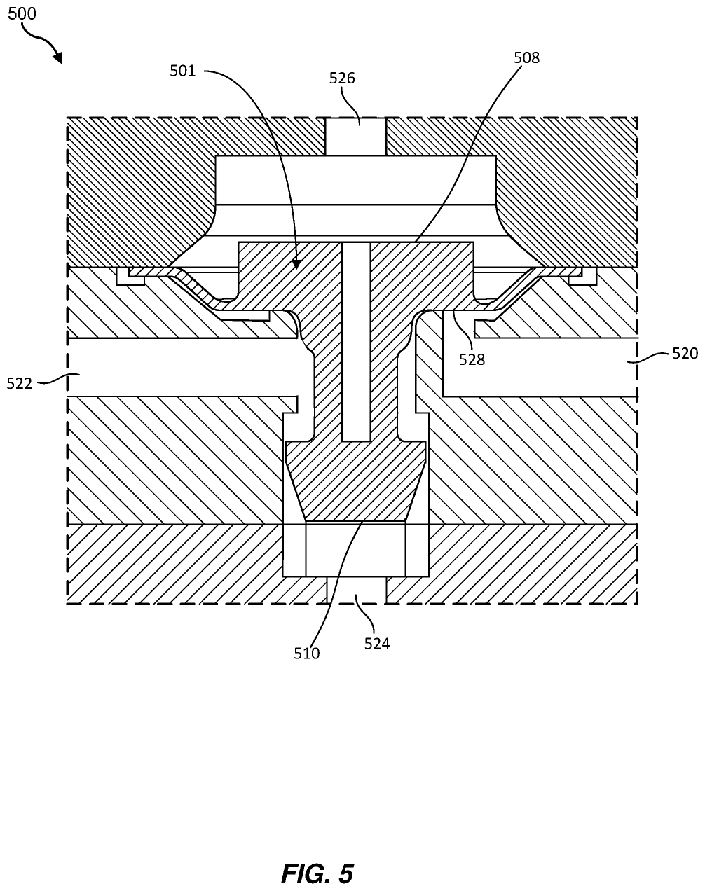

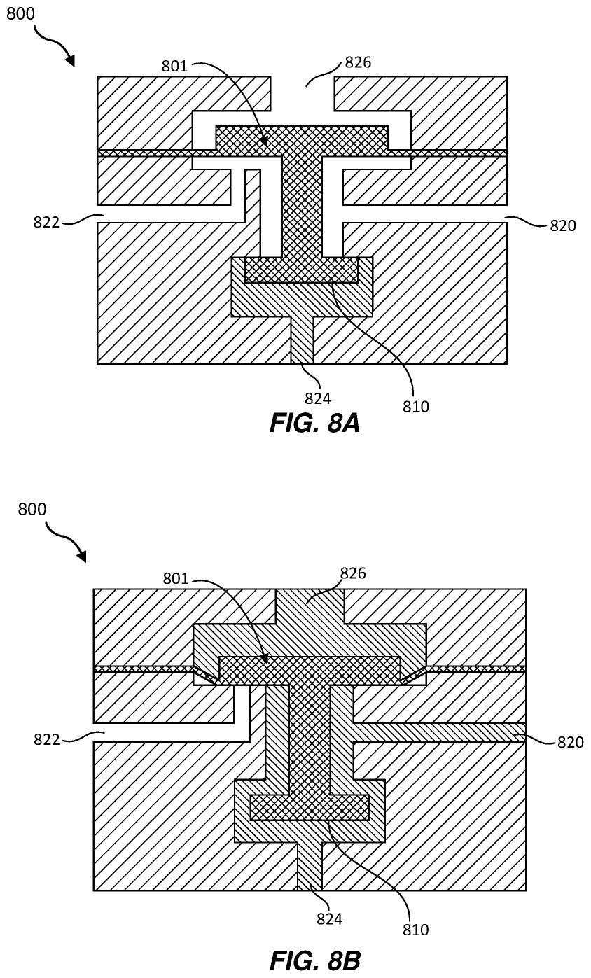

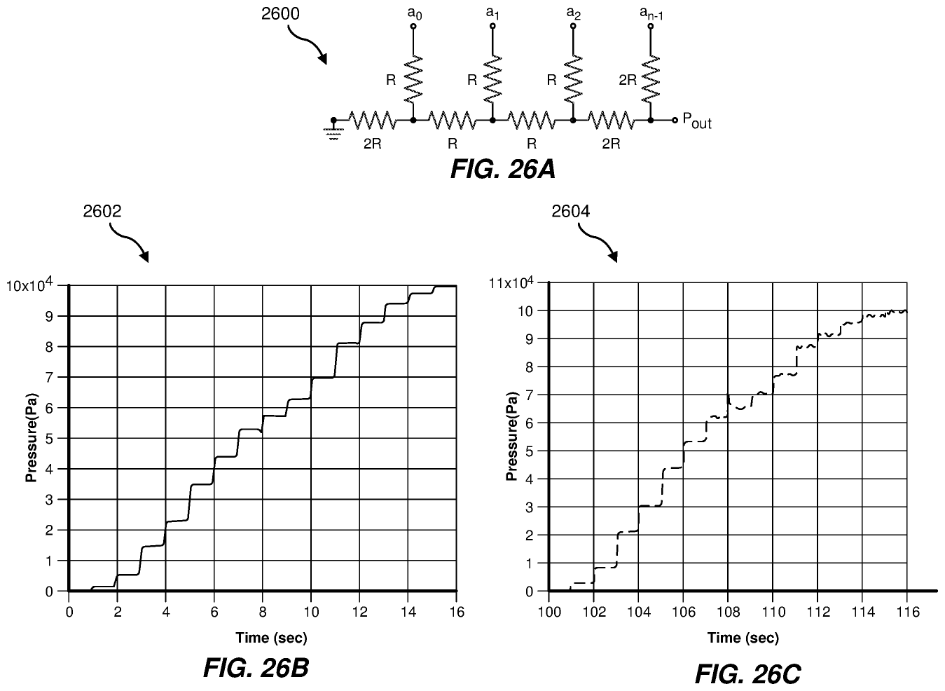

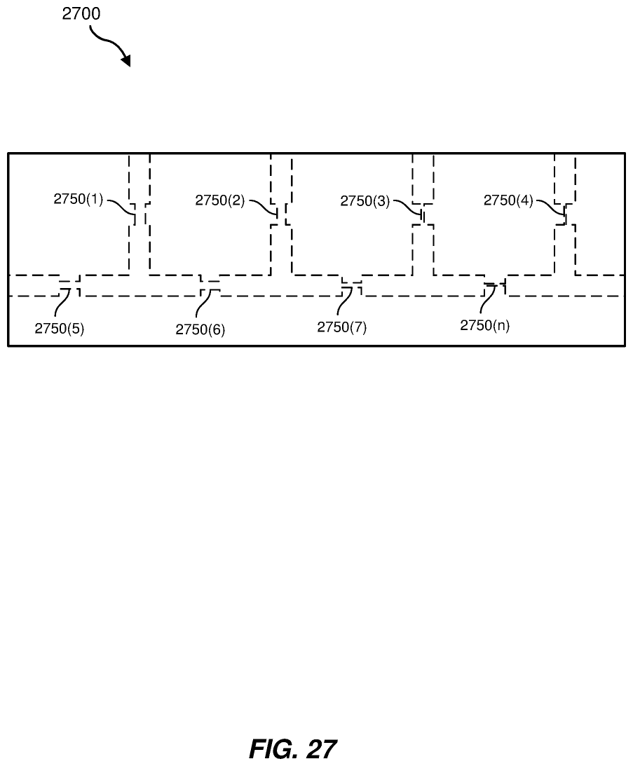

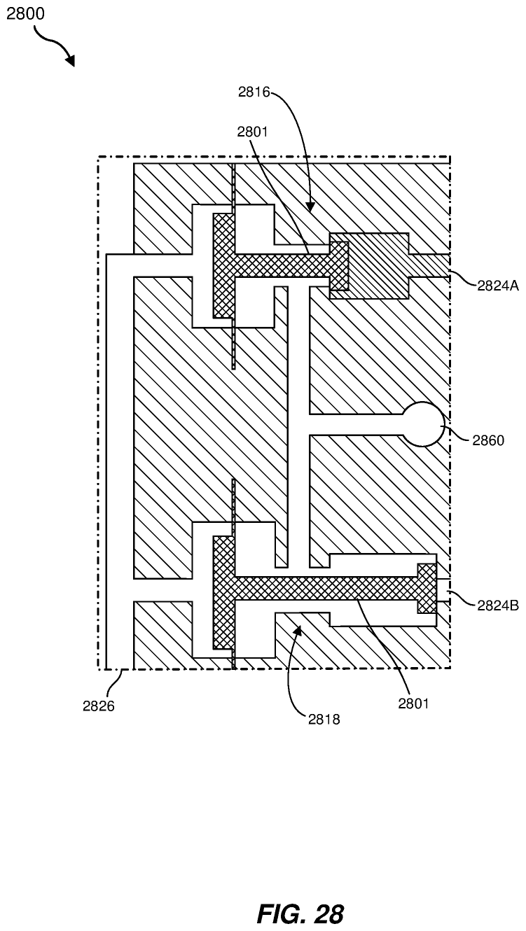

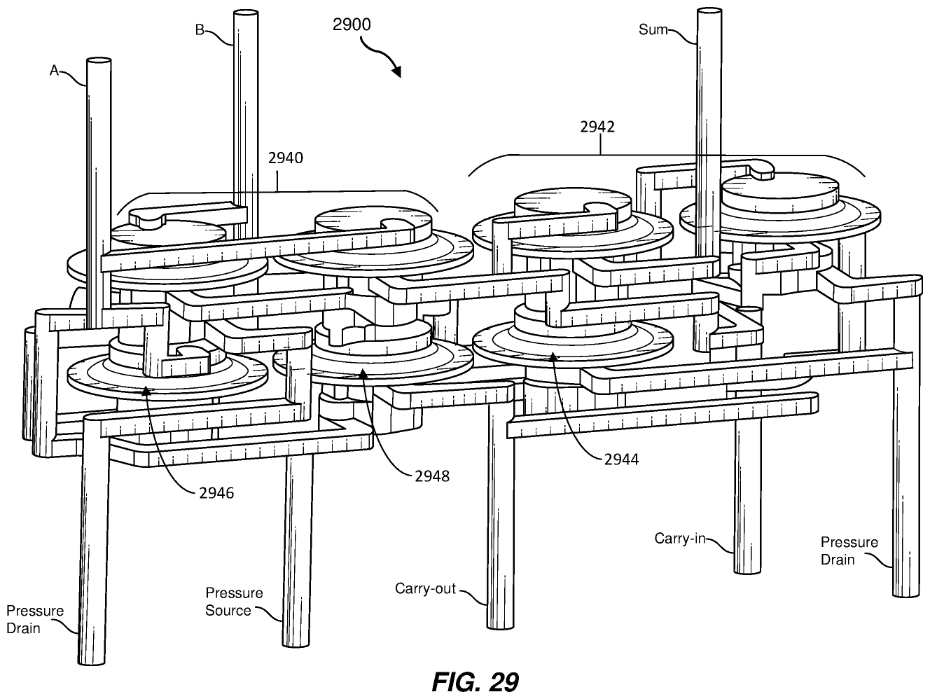

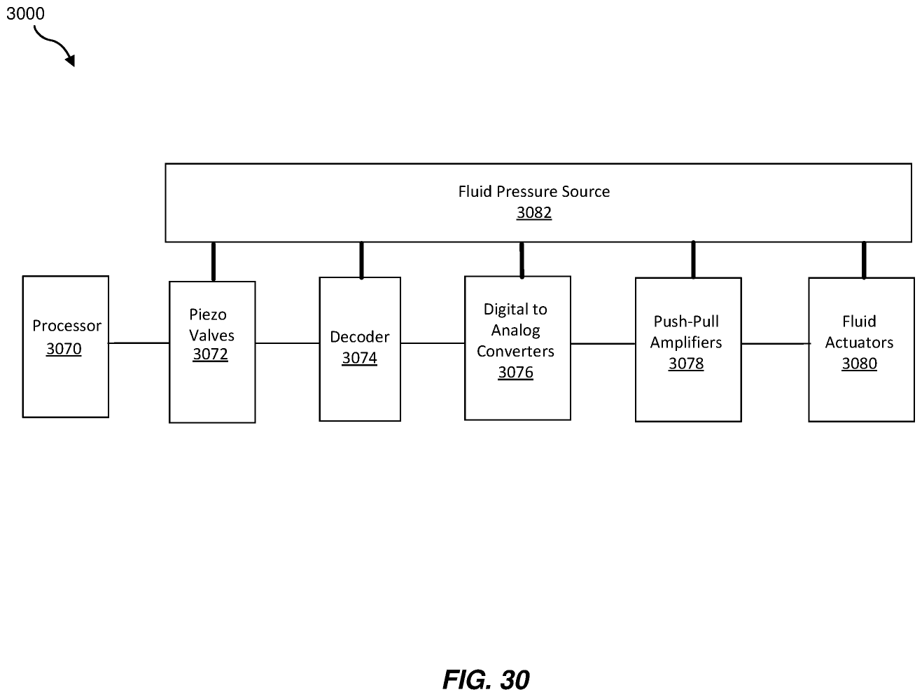

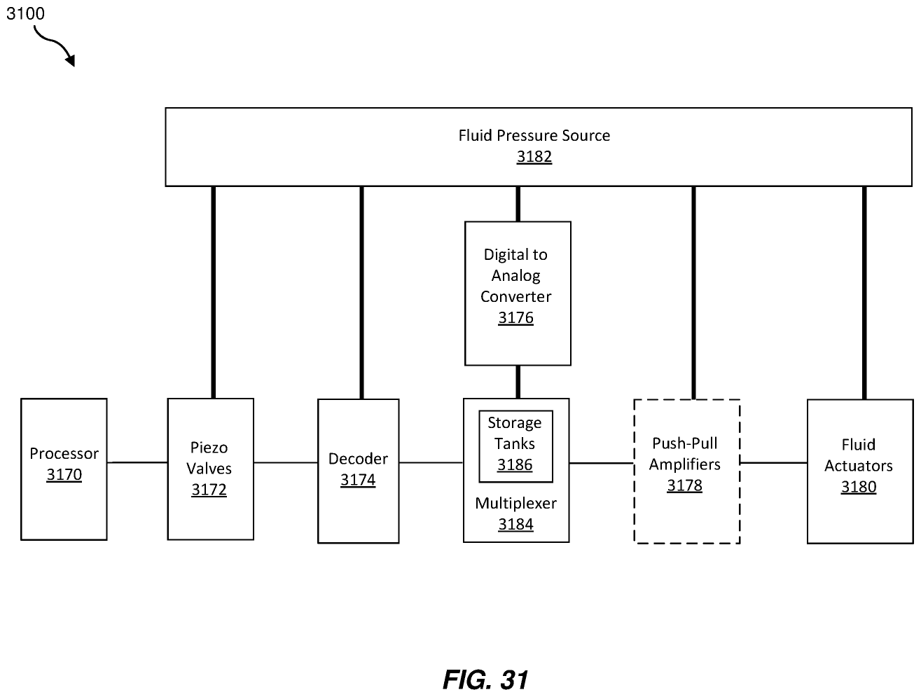

The following will provide, with reference to FIGS. 1-4, detailed descriptions of example fluidic valve pistons, fluidic systems, and fluidic valves (e.g., microfluidic systems and microfluidic valves). Detailed descriptions of fluidic valve implementations are provided with reference to FIGS. 5-7. Detailed descriptions of logic gates and fluidic logic circuits are provided with reference to FIGS. 8-25. Detailed descriptions of linearized variable pressure regulator devices are provided with reference to FIGS. 26A-26C and 27. A detailed description of a push-pull fluidic amplifier is provided with reference to FIG. 28. A detailed description of a physical implementation of a full adder is provided with reference to FIG. 29. A detailed description of a microfluidic control system is provided with reference to FIG. 30. With reference to FIGS. 31-35, detailed descriptions are provided of example systems and devices for haptics, artificial reality, and virtual reality that may be used in conjunction with the microfluidic systems of the present disclosure.

FIG. 1 is an illustration of an example piston 100 of a fluidic valve (e.g., a microfluidic valve) biased in a down position, according to at least one embodiment of the present disclosure. Piston 100 may be configured to be positioned within a fluidic valve device to control a direction of flow and/or pressure of the fluid (e.g., air, a gas, a liquid, etc.). Piston 100 may include a flange 102 along an outer perimeter of piston 100 that may be shaped and sized for securing within a corresponding flange receptacle area in the fluidic valve body. Flange 102 may be configured to anchor piston 100 to the fluidic valve such that a shaft 104 of piston 100 may move in a vertical direction (as viewed from the perspective of FIG. 1) relative to the fluidic valve body. The flange 102 may extend radially outward from shaft 104.

Piston 100 may further include a flexible sloped region 106 (e.g., a hinge portion) between flange 102 and shaft 104 of piston 100. Flexible sloped region 106 may be configured to allow shaft 104 of flexible sloped region 106 to move vertically relative to the valve body while flange 102 portion remains fixed within the valve body. Piston 100 may include a flexible material including, without limitation, rubber, polymer, nitrile, silicone, or a combination thereof. The flexible material may be configured to allow shaft 104 of piston 100 to move vertically while the flange remains fixed with respect to the fluidic valve body.

Advantages of the present disclosure over traditional piston designs may include the ability to scale the size of piston 100 down to dimensions that allow large scale integration of a plurality of pistons 100 (e.g., dozens, hundreds, or thousands of pistons) into a compact fluidic system package (e.g., full adder 2900 of FIG. 29, fluidic system 3000 of FIG. 30). For example, the outer diameter of flange 102 may be less than 10 mm, less than 5 mm, less than 2 mm, or less than 1 mm. Another advantage of the present disclosure over traditional piston designs may include the high reliability of piston 100 after repeated cycling (e.g., thousands or millions of cycles) of piston 100 in a microfluidic system (e.g., fluidic system 3000 of FIG. 30).

Piston 100 may include a gate 108 (e.g., a control gate) disposed on the top center region of piston 100. Gate 108 may be positioned and configured to receive a positive fluid pressure that applies a force to piston 100, causing piston 100 to move down in the vertical direction (as viewed from the perspective of FIG. 1). Piston 100 may further include a base 110 disposed in the lower region (as viewed from the perspective of FIG. 1) of piston 100. Base 110 may be positioned and configured to receive a positive fluid pressure that applies a force to piston 100 causing piston 100 to move up in the vertical direction (as viewed from the perspective of FIG. 1). Piston 100 may also include features that assist in the process of assembling piston 100 into a valve body (e.g., a machined or molded acrylic body as described below with reference to FIGS. 5, 8A, and 8B). For example, base 110 of piston 100 may be tapered such that the bottom of base 110 (as viewed from the perspective of FIG. 1) may include a diameter D1 that is smaller than a diameter D2 at the top of base 110 to assist in the insertion of piston 100 into the valve body. In addition, the tapered base 110 may facilitate sealing base 110 against a valve seat when piston 100 is in a down position. Piston 100 may also include a hole 112 extending through the center of piston 100 to assist insertion tooling when installing piston 100 into the valve body.

Piston 100 may be configured to be actuated through multiple positions. In some examples, piston 100 may be actuated through two positions (e.g., binary actuation). For example, piston 100 may be actuated to a down position (as viewed from the perspective of FIG. 1) when sufficient positive pressure is applied to gate 108. Piston 100 may be actuated to an up position (as viewed from the perspective of FIG. 1) when sufficient positive pressure is applied to base 110 and/or to a lower surface of flexible shaped region 106. In some examples, piston 100 may be biased to a certain position in the absence of fluid pressure on gate 108 or base 110. As shown in FIG. 1, piston 100 may be biased to a down position in the absence of fluid pressure on gate 108 or base 110. The downward bias may be accomplished by the configuration of flexible sloped region 106 extending downward from flange 102 to shaft 104.

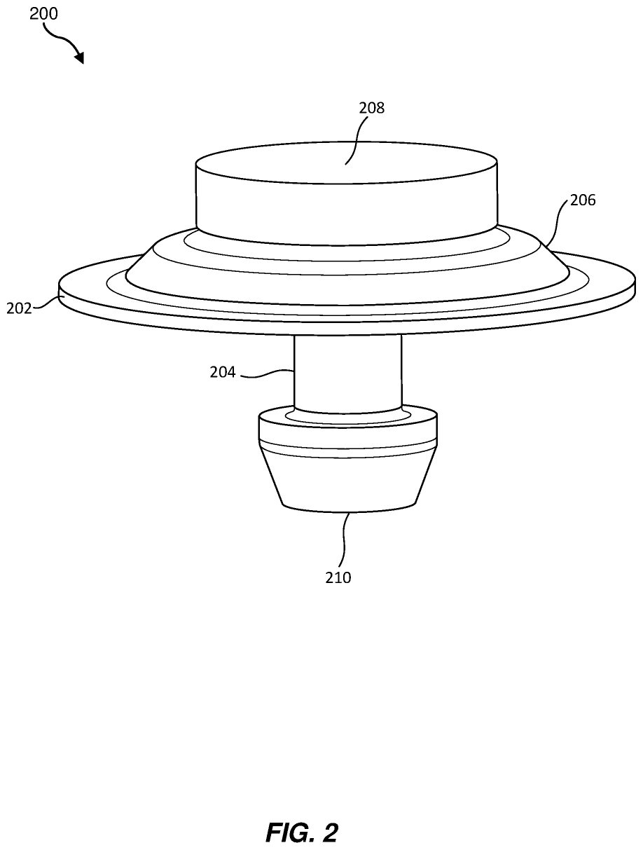

FIG. 2 is an illustration of an example piston 200 of a fluidic valve (e.g., a microfluidic valve) biased in an up position, according to at least one embodiment of the present disclosure. In some respects, piston 200 may be similar to piston 100 of FIG. 1. For example, piston 200 may also include a gate 208 positioned and configured to receive a fluid pressure that applies a force to piston 200, causing piston 200 to move down in the vertical direction (as viewed from the perspective of FIG. 2) and a base 210 disposed in a lower region of piston 200. Base 210 may be positioned and configured to receive a fluid pressure that applies a force to piston 200 causing piston 200 to move up in the vertical direction (as viewed from the perspective of FIG. 2). Piston 200 may include a flange 202 on the outer perimeter of piston 200, a shaft 204, and a flexible sloped region 206 (e.g., a hinge portion) between flange 202 and shaft 204.

Piston 200 may also be configured to be actuated through multiple positions including two positions (e.g., binary actuation). For example, piston 200 may be actuated to a down position (as viewed from the perspective of FIG. 2) when pressure is applied to gate 208 and actuated to an up position (as viewed from the perspective of FIG. 2) when pressure is applied to base 210 and/or to a lower surface of flexible sloped region 206. In some examples, piston 200 may also be biased to a certain position in the absence of fluid pressure on gate 208 or base 210. In contrast to the biased-down position of piston 100 in FIG. 1, piston 200 may be biased to an up position in the absence of fluid pressure on gate 208 or base 210. The upward bias may be accomplished by the configuration of flexible sloped region 206 extending upward from flange 202 to shaft 204.

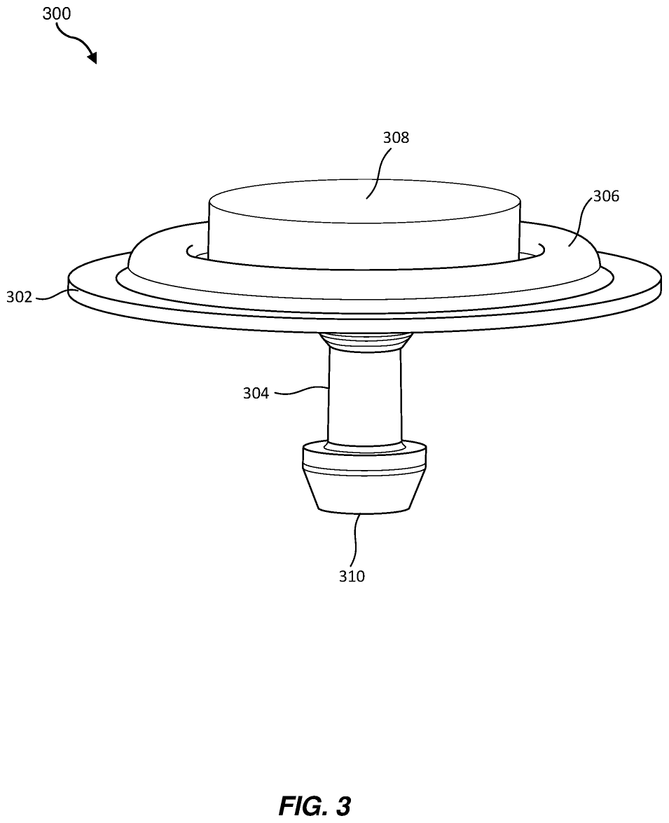

FIG. 3 is an illustration of an example piston 300 of a fluidic valve (e.g., a microfluidic valve) biased to a center position, according to at least one embodiment of the present disclosure. In some respects, piston 300 may be similar to piston 100 of FIG. 1 and piston 200 of FIG. 2. For example, piston 300 may also include a gate 308 positioned and configured to receive a fluid pressure that applies a force to piston 300, causing piston 300 to move down in the vertical direction (as viewed from the perspective of FIG. 3) and a base 310 disposed in the lower region of piston 300. Base 310 may be positioned and configured to receive a fluid pressure that applies a force to piston 300 causing piston 300 to move up in the vertical direction (as viewed from the perspective of FIG. 3). Piston 300 may include a flange 302 on the outer perimeter of piston 300, a shaft 304, and a flexible region 306 (e.g., a hinge portion) between flange 302 and shaft 304.

Piston 300 may also be configured to be actuated through multiple positions. In contrast to piston 100 of FIG. 1 and piston 200 of FIG. 2, piston 300 may be actuated through three positions. For example, piston 300 may be actuated to a down position (as viewed from the perspective of FIG. 3) when pressure is applied to gate 308 and actuated to an up position (as viewed from the perspective of FIG. 3) when pressure is applied to base 310 and/or to a lower surface of flexible region 306. In some examples, piston 300 may also be biased to a certain position in the absence of fluid pressure on gate 308 or base 310. In contrast to the biased down position of piston 100 in FIG. 1 and the biased up position of piston 200 in FIG. 2, piston 300 may be biased to a center position in the absence of fluid pressure on gate 308 or base 310. The central bias may be accomplished by the configuration of flexible region 306 extending inward (albeit along a ridged, valleyed, or undulating path) from flange 302 to shaft 304.

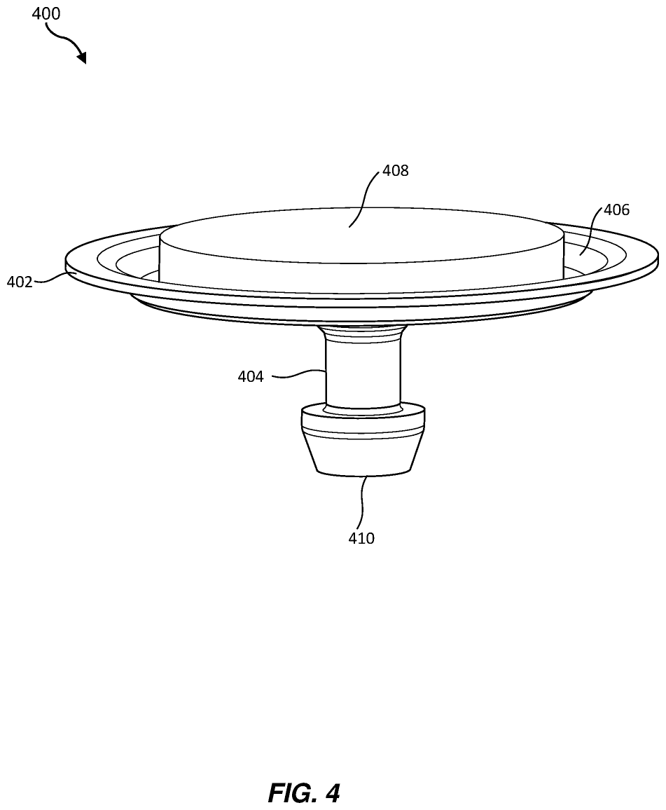

FIG. 4 is an illustration of an example piston 400 of a fluidic valve (e.g., a microfluidic valve) configured with a high gain gate 408, according to at least one embodiment of the present disclosure. In some respects, piston 400 may be similar to piston 100 of FIG. 1, piston 200 of FIG. 2, and piston 300 of FIG. 3. For example, piston 400 may also include gate 408 positioned and configured to receive a fluid pressure that applies a force to piston 400, causing piston 400 to move down in the vertical direction (as viewed from the perspective of FIG. 4) and a base 410 disposed in the lower region of piston 400. Base 410 may be positioned and configured to receive a fluid pressure that applies a force to piston 400 causing piston 400 to move up in the vertical direction (as viewed from the perspective of FIG. 4). Piston 400 may include a flange 402 on the outer perimeter of piston 400, a shaft 404, and a flexible sloped region 406 (e.g., a hinge portion) between flange 402 and shaft 404.

In contrast to piston 100 of FIG. 1, piston 200 of FIG. 2, and piston 300 of FIG. 3, gate 408 of piston 400 of FIG. 4 may be configured with a larger surface area than gates 108, 208, and 308. The larger surface area of gate 408 may be configured to provide a higher force in a downward direction (as viewed from the perspective of FIG. 4) as compared to the downward force of gates 108, 208, and 308 for any given fluid pressure that is applied. In some examples, piston 400 may be configured to switch from an up position to a down position faster than pistons 100, 200, or 300 due to the higher force applied to piston 400 by the larger surface area of piston 400.

Piston 400 may also be configured to be actuated through multiple positions including two positions (e.g., binary actuation) or three positions. For example, piston 400 may be actuated to a down position (as viewed from the perspective of FIG. 4) when pressure is applied to gate 408 and actuated to an up position (as viewed from the perspective of FIG. 4) when pressure is applied to base 410 and/or to a lower surface of flexible sloped region 406. In some examples, piston 400 may also be biased to a certain position in the absence of fluid pressure on gate 408 or base 410. In some examples, piston 400 may be biased to an up position, a central position, or a down position in the absence of fluid pressure on gate 408 or base 410.

FIG. 5 is a cross-sectional view of an example fluidic valve 500, according to at least one embodiment of the present disclosure. In some examples, fluidic valve 500 may be configured to control the flow of a fluid to a fluid mechanism. Fluidic valve 500 may be fluidly coupled to, for example, a fluid-driven mechanism (e.g., a fluid actuator, a haptic device, an inflatable bladder, etc.), a fluid channel, another fluidic valve, a fluid reservoir, or a combination thereof.

Fluidic valve 500 (e.g., a microfluidic valve) described with reference to FIG. 5 may include a first port 522 (e.g., a first input channel, a first inlet) that is configured to convey a first fluid from a fluid source (e.g., a piezoelectric valve, a pressurized fluid source, a fluid pump, compressed air, etc.) exhibiting a pressure into fluidic valve 500. A base port 524 (e.g., a second inlet channel, a second inlet port) may be configured to convey a second fluid from a fluid source (e.g., a piezoelectric valve, a pressurized fluid source, a fluid pump, compressed air, etc.) exhibiting a pressure into fluidic valve 500. Second port 520 (e.g., an output channel) may be configured to convey one of the first fluid from first port 522 or the second fluid from base port 524 out of fluidic valve 500. Second port 520 may be fluidly coupled to, for example, a fluid-driven mechanism (e.g., a fluid actuator, a haptic device, an inflatable bladder, etc.), another fluid channel, another fluidic valve, a fluid reservoir, or a combination thereof. Each of first port 522, second port 520, and base port 524 may be configured as a pressure source port or a pressure drain port depending on how fluidic valve 500 is coupled within a fluidic system.

The movement of a piston 501 between a first position (e.g., an up position as viewed from the perspective of FIG. 5) and a second position (e.g., a down position as viewed from the perspective of FIG. 5) may control fluid flow through fluidic valve 500. A gate portion 508 may be movable between the up position that inhibits fluid flow from first port 522 to base port 524 and the down position that inhibits fluid flow from the first port 522 to second port 520. The movement of piston 501 between the up and down positions may be determined at least in part by control pressure applied against gate portion 508 (e.g., a control gate) of piston 501. Piston 501 may be a movable component that is configured to transmit an input force, pressure, or displacement to a flow restricting region of fluidic valve 500 to restrict or stop the fluid flow through base port 524, first port 522, and/or second port 520. Conversely, in some examples, application of a force, pressure, or displacement to piston 501 may result in opening the flow restricting region to allow or increase flow through base port 524, first port 522, and/or second port 520. In some examples, piston 501 may be movable between two positions (e.g., up position and down position) and second port 520 may always be fluidly coupled to either first port 522 or base port 524 depending on the position of piston 501.

In the embodiment illustrated in FIG. 5, pressurization of gate port 526 may cause the piston 501 to move to the down position fluidly coupling base port 524 to first port 522 and blocking second port 520. When gate port 526 is not pressurized, pressurization of second port 520 may cause piston 501 to move to the up position fluidly coupling first port 522 to second port 520 and blocking base port 524. Pressurization of second port 520 may apply a force to an underside region 528 of piston 501 causing piston 501 to move to the up position. In some examples, base port 524 or first port 522 may be constantly pressurized. When base port 524 or first port 522 is constantly pressurized and gate port 526 is pressurized at the same or similar pressure level, the force on gate portion 508 on the top of piston 501 in a downward direction may be greater than the force on piston 501 in the upward direction causing piston 501 to move downward. The force on piston 501 in a downward direction may be greater than the force on piston 501 in the upward direction due to the larger surface area of gate portion 508 as compared to the surface area of underside region 528 and the surface area of base 510 thereby creating a larger force in the downward direction.

In additional embodiments, the fluidic connection between first port 522, second port 520, and base port 524 may be different than the connection shown in FIG. 5. For example, when piston 501 is in the down position, base port 524 and second port 520 may be in fluid communication, allowing fluid to flow from base port 524 to second port 520. When piston 501 is in the up position, first port 522 and second port 520 may be in fluid communication, allowing fluid to flow from first port 522 to second port 520. This configuration is shown, for example, in FIGS. 8A and 8B.

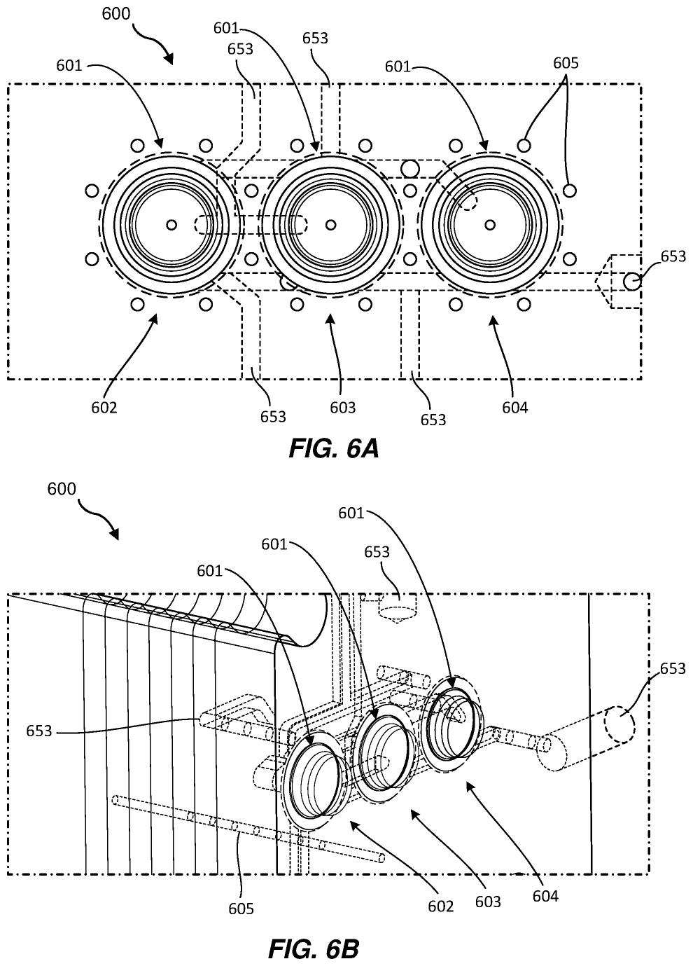

FIG. 6A is a plan view of example pistons 601 disposed in a fluidic valve assembly 600. FIG. 6B is a semitransparent perspective view of fluidic valve assembly 600 that includes multiple pistons 601. Fluidic valve assembly 600 may include multiple pistons 601 positioned and configured within fluidic valve assembly 600 to form a fluidic circuit including a first fluidic valve 602, a second fluidic valve 603, and a third fluidic valve 604. Fluidic valve assembly 600 may include multiple fluidic channels 653 that interconnect the fluidic valves 602, 603, 604 to each other and that fluidically connect the valve assembly 600 into a system (e.g., microfluidic control system 3000 of FIG. 30, a haptic system, etc.).

Fluidic valve assembly 600 may include multiple layers of material (e.g., an acrylic material) that are stacked and bonded to one another to facilitate manufacturing and assembly. Each of the layers may include features desired for large scale integration of microfluidic valve circuits including, without limitation, channels, vias, ports, pistons, seals, valves, electronics, or a combination thereof. Each of the layers may be sealed and/or bonded to an adjacent layer allowing the fluid to move through the internal components of fluidic valve assembly. In some examples, each of the layers may include an acrylic material. Each of the layers may also include through holes 605 that are positioned to line up with through holes 605 of adjacent layers, creating holes (e.g., fluid paths, fluid channels) that extend though the entire assembly. In some examples, the layers may be bonded to one another by injecting a solvent (e.g., acetone) into the through holes 605. The injected solvent may wick between the layers of acrylic. The injected solvent may act as a gluing agent to create a bond between the acrylic layers. In additional embodiments, a solid element (e.g., pin, screw, bolt, etc.) may be inserted into through holes 605 to secure the layers to each other.

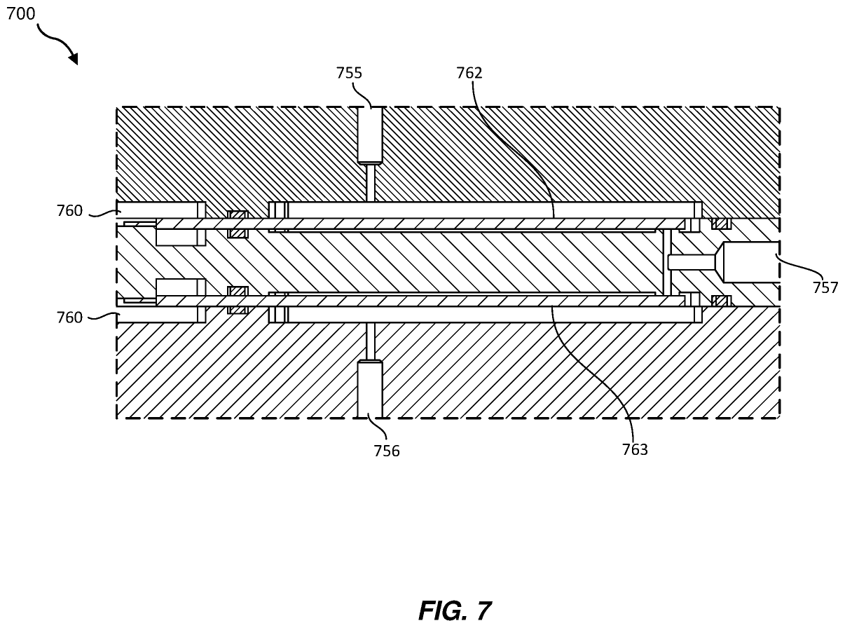

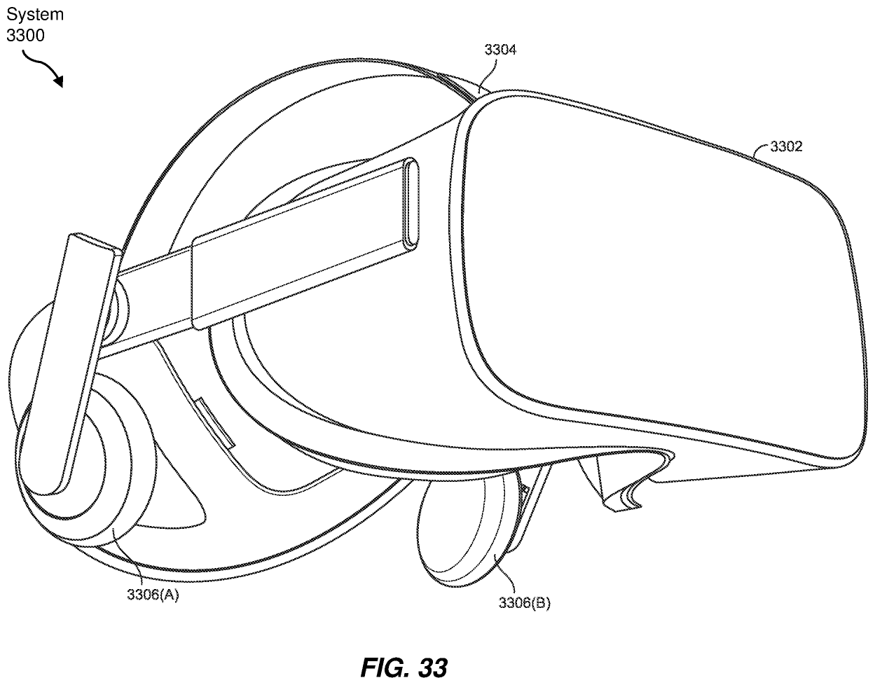

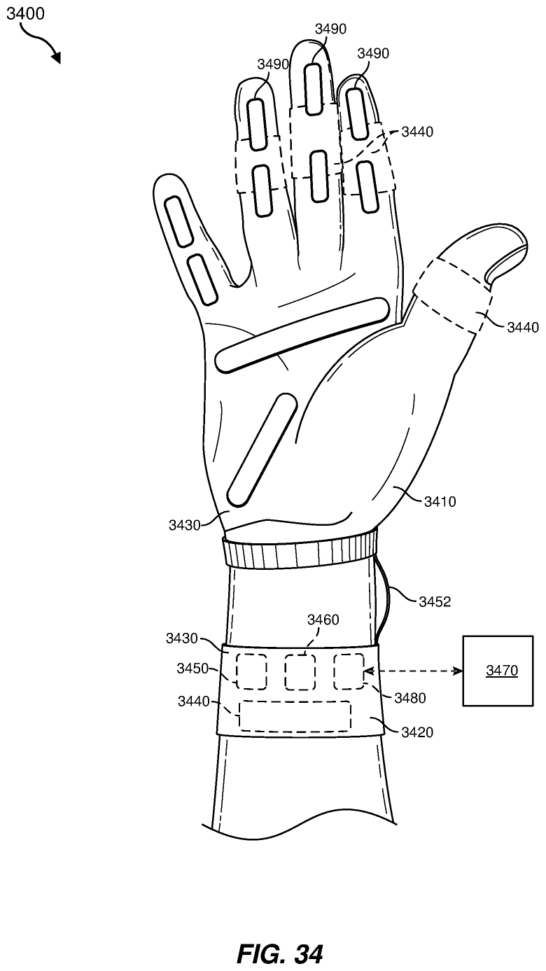

FIG. 7 is a cross-sectional view of a piezoelectric fluidic valve 700 (also referred to herein as “piezo valve 700”), according to at least one embodiment of the present disclosure. Piezo valve 700 may fluidically couple a pressurized fluid source at source port 755 to the output port 757 of piezo valve and/or fluidically couple a fluid drain at drain port 756 to output port 757 of piezo valve 700. In some examples, piezo valve 700 may provide a source and/or drain of pressurized fluid to a valve assembly such as the valve assemblies associated with FIGS. 6A, 6B, 8A, 8B, 9-16, 18-25, 27-31, and 34-35. Piezo valve 700 may be electrically actuated and may provide an interface between an electronic control system (e.g., an artificial-reality control system, a haptic control system, a fluidic logic control system, etc.) and a fluidic valve system (e.g., a fluidic valve system of haptic gloves of FIGS. 33-34). Piezo valve 700 may include electrical connections 760 to connect a first piezo actuator 762 and a second piezo actuator 763 to an electronic control system. In some examples, electrical connections 760 may be sealed off from source port 755 and drain port 756 of piezo valve 700 by O-rings, gaskets, glue, acetone bonding, or other sealing elements or materials. Piezo valve 700 may be manufactured by stacking layers of material. For example, 3 layers of acrylic material may be stacked and bonded according to the process described above with reference to FIGS. 6A and 6B. A first layer may include source port 755, a second layer may include output port 757, and the third layer may include drain port 756 as shown in FIG. 7.

In some examples, the pressure source may be a constantly pressurized source of fluid (e.g., compressed air at 15-30 PSI) applied to source port 755. The pressure drain applied to drain port 756 may be open to the ambient atmosphere (e.g., an exhaust port). Piezo valve 700 may include a first piezo actuator 762 and a second piezo actuator 763 (e.g., piezo-electric bending actuators, piezo-ceramic bending actuators) that may be configured as cantilevered beams secured on the left side of first piezo actuator 762 and second piezo actuator 763 (as viewed from the perspective of FIG. 7). First piezo actuator 762 may be positioned and configured to control the fluidic coupling between source port 755 and output port 757 and second piezo actuator 763 may be positioned and configured to control the fluidic coupling between drain port 756 and output port 757. Both first piezo actuator 762 and second piezo actuator 763 may be configured to be actuated in the same direction and at the same time. For example, first piezo actuator 762 and second piezo actuator 763 may be actuated in the downward direction (as viewed from the perspective of FIG. 7) such that an aperture between drain port 756 and output port 757 is opened allowing fluidic coupling between drain port 756 and output port 757 while an aperture between source port 755 and output port 757 is closed.

When first piezo actuator 762 and second piezo actuator 763 are actuated in the upward direction (as viewed from the perspective of FIG. 7) the aperture between source port 755 and output port 757 may open allowing fluidic coupling between source port 755 and output port 757 while the aperture between drain port 756 and output port 757 is closed. Both first piezo actuator 762 and second piezo actuator 763 may be in a substantially planar state when first piezo actuator 762 and second piezo actuator 763 are in a closed position (e.g., not electrically actuated or actuated to a closed position), thereby closing the apertures and blocking fluid flow. Both first piezo actuator 762 and second piezo actuator 763 may apply their peak amount of force against the apertures when in the substantially planar state as compared to a deformed state (e.g., an electrically actuated state). The higher force applied to the apertures by first piezo actuator 762 and second piezo actuator 763 may reduce fluid leakage from source port 755 to output port 757 and from output port 757 to drain port 756.

In some examples, using first piezo actuator 762 and second piezo actuator 763 in piezo valve 700 may allow the volume of the fluid channel between the two sealing surfaces of piezo valve 700 to be reduced. This reduction in volume may reduce the amount of fluid required to fill the volume and/or drain from the volume when switching between high and low pressure within the channel, thereby enabling faster switching frequencies (e.g., switching frequencies of hundreds of cycles per second) as compared to traditional piezo valves that may include a single piezo actuator.

Potential advantages of piezo valve 700 may include a faster response time in switching piezo valve 700, higher operating fluid pressures, and/or higher fluid flow rates, as compared to traditional piezo valves.

FIGS. 8A and 8B are cross-sectional views of an example fluidic valve buffer 800, according to at least one embodiment of the present disclosure. Fluidic valve buffer 800 may be the same as or similar to fluidic valve 500 described with reference to FIG. 5. Fluidic valve buffer 800 may include a base port 824 coupled to a pressurized fluid source (e.g., a fluid pump, compressed air, etc.) while a first port 822 is coupled to a pressure drain (e.g., open to atmospheric pressure). As shown in FIG. 8A, when a gate port 826 is not pressurized, the pressure in base port 824 may apply a force to the bottom of a piston 801 at base 810 causing piston 801 to move in an upwards direction (as viewed from the perspective of FIG. 8A) and open a fluid path between first port 822 and second port 820, coupling the pressure (e.g., atmospheric pressure) on first port 822 to second port 820. As shown in FIG. 8B, when gate port 826 is pressurized, piston 801 may move in a downwards direction (as viewed from the perspective of FIG. 8B) and open a fluid path between base port 824 and a second port 820, coupling the pressurized fluid from base port 824 to second port 820. In some examples, fluidic valve buffer 800 of FIGS. 8A and 8B may be configured to mirror the pressure state (e.g., pressurized or unpressurized) of gate port 826 onto the pressure state of second port 820 while providing a different (e.g., higher or lower) fluid pressure and/or fluid flow rate from first port 822 and/or base port 824 than is provided by the fluid at gate port 826.

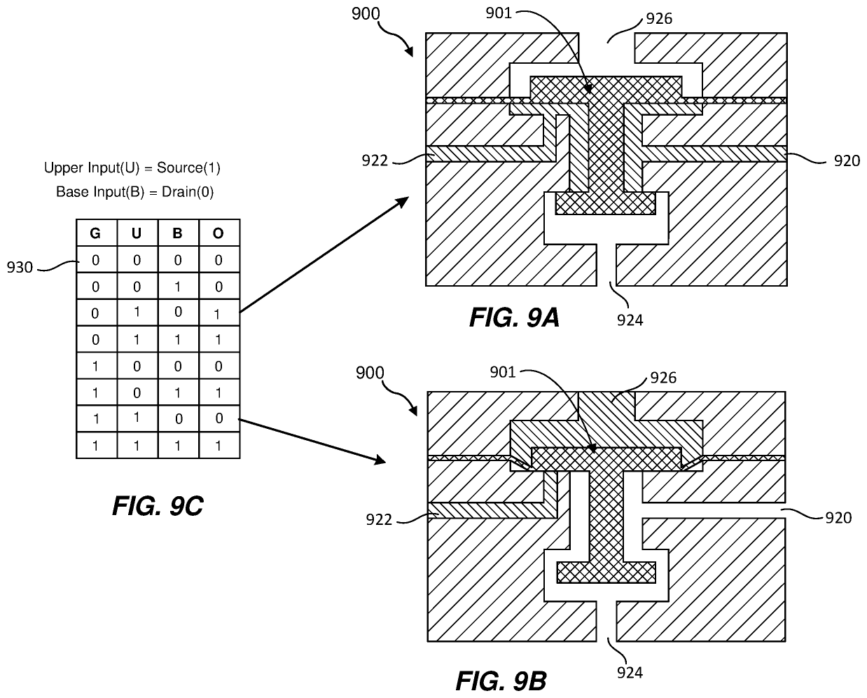

FIGS. 9A and 9B are cross-sectional views of an example fluidic valve inverter 900, according to at least one embodiment of the present disclosure. Fluidic valve inverter 900 may include fluidic valve 500 described with reference to FIG. 5. Fluidic valve inverter 900 may include a base port 924 (lower port as viewed from the perspective of FIGS. 9A and 9B) coupled to a low-pressure drain (e.g., open to atmospheric pressure) while a first port 922 (left port as viewed from the perspective of FIGS. 9A and 9B) is coupled to a high-pressure source. Fluidic valve inverter 900 may be configured to operate according to a truth table 930 of FIG. 9C.

When a gate port 926 is pressurized, a piston 901 may move in a downwards direction as shown in FIG. 9B and open a fluid path between base port 924 and a second port 920, coupling second port 920 to base port 924. When gate port 926 is not pressurized, pressure in first port 922 may apply a force to the sloped region of piston 901 and/or the underside of the gate region of piston 901 causing piston 901 to move in an upwards direction as shown in FIG. 9A and open a fluid path between first port 922 and second port 920, coupling the pressurized fluid of first port 922 to second port 920. Fluidic valve inverter 900 of FIG. 6 may mirror an inverted pressure state of gate port 926 onto the pressure state of second port 920. In some examples, fluidic valve inverter 900 may be configured as part of a fluidic valve combinatorial logic circuit and provide an inverting function for the logic circuit.

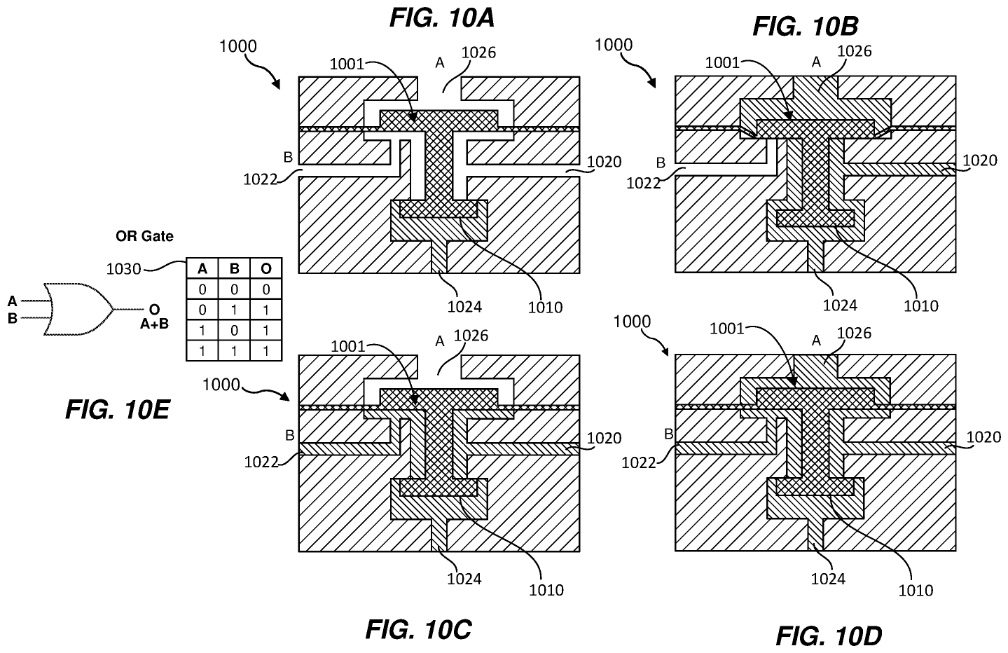

FIGS. 10A-10D are cross-sectional views of an example OR fluidic logic-gate device 1000 (OR gate), according to at least one embodiment of the present disclosure. FIG. 10E is a truth table 1030 corresponding to OR gate 1000. OR gate 1000 may include the fluidic valve described with reference to FIG. 5. OR gate 1000 may include a base port 1024 coupled to a pressurized source. A first port 1022 (also labeled B in FIGS. 10A-10D) and a gate port 1026 (also labeled A in FIGS. 10A-10D) may receive fluid inputs that include a high-pressure source (logic 1) or a low-pressure drain (logic 0). OR gate 1000 may be configured to operate according to logic truth table 1030.

When both gate port 1026 and first port 1022 are at a low pressure (logic 0), the source pressure on base port 1024 may apply a force to a base 1010 of a piston 1001 causing piston 1001 to move in an upwards direction (as viewed from the perspective of FIGS. 10A-10D) and open a fluid path between first port 1022 and second port 1020, coupling the low pressure to second port 1020. When gate port 1026 is at a low pressure (logic 0) and first port 1022 is at a high pressure (logic 1), the pressure in base port 1024 may apply a force to base 1010 of piston 1001 causing the piston 1001 to move in an upwards direction (as viewed from the perspective of FIGS. 10A-10D) and open a fluid path between first port 1022 and second port 1020, coupling the high pressure to second port 1020.

When gate port 1026 is at a high pressure (logic 1) and first port 1022 is at a low pressure (logic 0), the high pressure in gate port 1026 may apply a force to the top of piston 1001 causing the piston to move in a downwards direction (as viewed from the perspective of FIGS. 10A-10D) and open a fluid path between base port 1024 and second port 1020, coupling the high pressure to second port 1020. When gate port 1026 and first port 1022 are at a high pressure (logic 1), the high pressure in gate port 1026 may apply a force to the top of piston 1001 causing the piston 1001 to move in a downwards direction (as viewed from the perspective of FIGS. 10A-10D) and open a fluid path between first port 1022 and second port 1020, coupling the high pressure to second port 1020. In some examples, OR gate 1000 may be part of a fluidic valve combinatorial logic circuit and provide a logical OR function for the logic circuit.

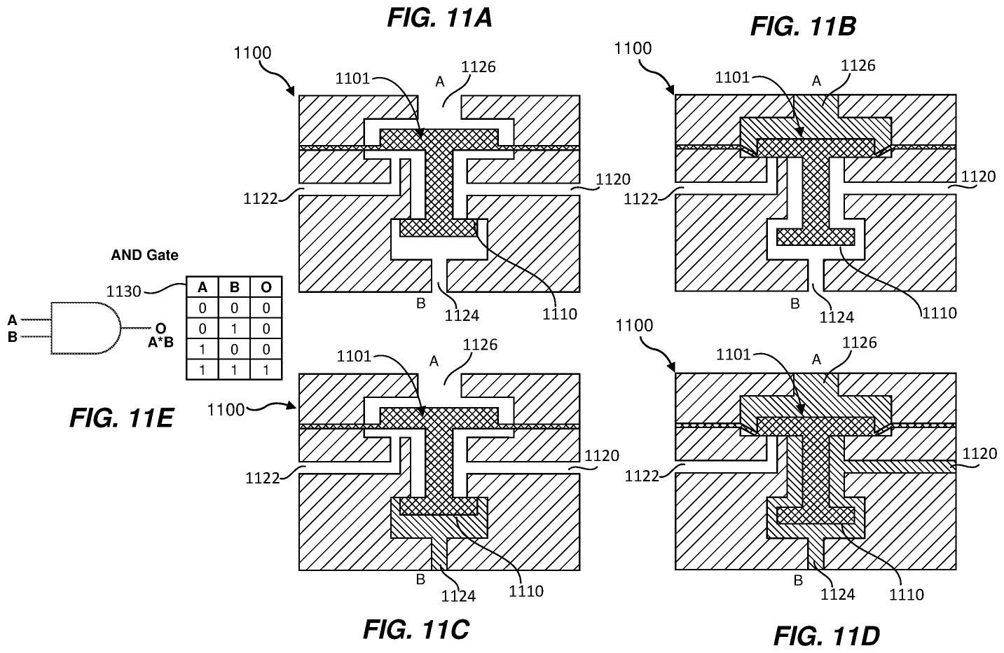

FIGS. 11A-11D are cross-sectional views of an example AND fluidic logic-gate device 1100 (AND gate), according to at least one embodiment of the present disclosure. FIG. 11E is a truth table 1130 corresponding to the AND gate 1100. AND gate 1100 may include fluidic valve 500 described with reference to FIG. 5. AND gate 1100 may include a first port 1122 coupled to a low pressure (e.g., open to atmospheric pressure). A base port 1124 (labeled B in FIGS. 11A-11D) and a gate port 1126 (labeled A in FIGS. 11A-11D) may receive fluid inputs that include a high pressure (logic 1) or a low pressure (logic 0). AND 1100 gate may be configured to operate according to a logic truth table 1130.

When both gate port 1126 and base port 1124 are at a low pressure (logic 0), the elastomeric properties of a piston 1101 may be configured to cause piston 1101 to form into a shape that moves piston 1101 to an upward position (as viewed from the perspective of FIGS. 11A-11D) and open a fluid path between first port 1122 and a second port 1120, coupling the low pressure to second port 1120. When gate port 1126 is at a low pressure (logic 0) and base port 1124 is at a high pressure (logic 1), the high pressure in base port 1124 may apply a force to a base 1110 on the bottom of piston 1101 causing piston 1101 to move in an upwards direction (as viewed from the perspective of FIGS. 11A-11D) and open a fluid path between first port 1122 and second port 1120, coupling the low pressure to second port 1120. When gate port 1126 is at a high pressure (logic 1) and base port 1124 is at a low pressure (logic 0), the high pressure may apply a force to the top of piston 1101 causing piston 1101 to move in a downwards direction (as viewed from the perspective of FIGS. 11A-11D) and open a fluid path between base port 1124 and second port 1120, coupling the low pressure to second port 1120.

When gate port 1126 and base port 1124 are each at a high pressure (logic 1), the high pressure in gate port 1126 may apply a downward force to the top of piston 1101 and the high pressure in base port 1124 may apply an upward force to base 1110 of piston 1101. In some examples, the high pressure in gate port 1126 may be substantially the same as the high pressure in base port 1124. However, the downward force on piston 1101 and the upward force on piston 1101 may not be substantially equal due to the unequal surface areas of the top of piston 1101 and base 1110 of piston 1101. As described above with reference to FIG. 5, the force on piston 1101 in the downward direction may be greater than the force on piston 1101 in the upward direction due to the larger surface area of the top of piston 1101 as compared to the surface area of the underside region of base 1110 thereby creating a larger force in the downward direction. The sum of the forces acting on piston 1101 may cause piston 1101 to move in a downwards direction (as viewed from the perspective of FIGS. 11A-11D) and open a fluid path between base port 1124 and second port 1120, coupling the high pressure to second port 1120. In some examples, AND gate 1100 may be part of a fluidic valve combinatorial logic circuit and provide a logical AND function for the logic circuit.

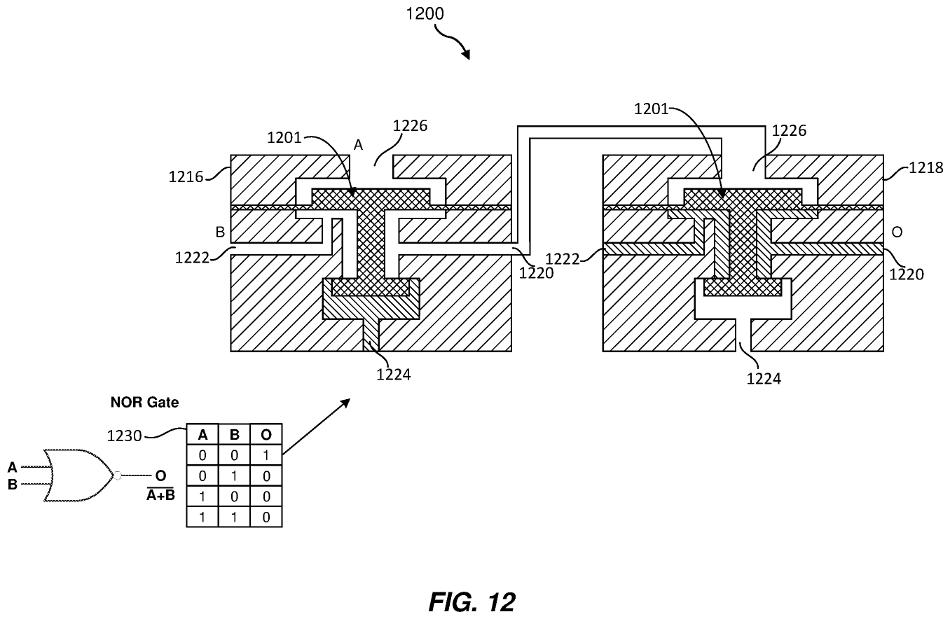

FIG. 12 is a cross-sectional view of an example NOR fluidic logic-gate device 1200 (NOR gate), according to at least one embodiment of the present disclosure. NOR gate 1200 may include a first fluidic valve 1216 (left side fluidic valve as viewed from the perspective of FIG. 12) and a second fluidic valve 1218 (right side fluidic valve as viewed from the perspective of FIG. 12). First fluidic valve 1216 and second fluidic valve 1218 may each include fluidic valve 500 described with reference to FIG. 5.

First fluidic valve 1216 may be configured as the OR gate of FIGS. 10A-10D and second fluidic valve 1218 may be configured as the inverter of FIGS. 9A-9B. First fluidic valve 1216 may include a base port 1224 coupled to a high-pressure source. First port 1222 (labeled as B in FIG. 12) and gate port 1226 (labeled as A in FIG. 12) may receive fluid inputs that exhibit a high pressure (logic 1) or a low pressure (logic 0). A second port 1220 of first fluidic valve 1216 may be inverted by second fluidic valve 1218. To this end, second port 1220 of first fluidic valve 1216 may be fluidically coupled to a gate port 1226 of second fluidic valve 1218. First port 1222 of second fluidic valve 1218 may be coupled to a high pressure (e.g., a source) and base port 1224 of second fluidic valve 1218 may be coupled to a low pressure (e.g., a drain, atmospheric pressure, etc.). Second port 1220 (labeled O in FIG. 12) of second fluidic valve 1218 may be an output of NOR gate 1200. NOR gate 1200 may be configured to operate according to the logic truth table 1230 shown in FIG. 12.

Corresponding to the first row of truth table 1230, when both gate port 1226 (A) and the first port 1222 (B) of first fluidic valve 1216 are coupled to a low pressure (logic 0), the source pressure on base port 1224 of first fluidic valve 1216 may apply a force to the bottom of piston 1201 causing piston 1201 to move in an upwards direction (as viewed from the perspective of FIG. 12) and open a fluid path between first port 1222 and second port 1220, coupling the low pressure to second port 1220. Corresponding to the second row of truth table 1230, when gate port 1226 (A) of first fluidic valve 1216 is coupled to a low pressure (logic 0) and first port 1222 (B) of first fluidic valve 1216 is coupled to a high pressure (logic 1), the source pressure on base port 1224 may apply a force to the bottom of piston 1201 causing the piston to move in an upwards direction (as viewed from the perspective of FIG. 12) and open a fluid path between first port 1222 and second port 1220 of first fluidic device 1216, coupling the high-pressure source to second port 1220 of first fluidic device 1216.

Corresponding to the third row of truth table 1230, when gate port 1226 of first fluidic valve 1216 is coupled to a high pressure (logic 1) and first port 1222 of first fluidic valve 1216 is coupled to a low pressure (logic 0), the high pressure on gate port 1226 may apply a force to the top of piston 1201 causing the piston to move in a downwards direction (as viewed from the perspective of FIG. 12) and open a fluid path between gate port 1226 and second port 1220, coupling the high pressure to second port 1220. Corresponding to the last row of truth table 1230, when gate port 1226 and first port 1222 of first fluidic valve 1216 are coupled to a high pressure (logic 1), the high pressure on gate port 1226 may apply a force to the top of piston 1201 causing the piston to move in a downwards direction (as viewed from the perspective of FIG. 12) and open a fluid path between first port 1222 and second port 1220, coupling the high pressure to second port 1220 of first fluidic valve 1216.

As noted above, second port 1220 of first fluidic valve 1216 may be fluidically coupled to gate port 1226 of second fluidic valve 1218. Second fluidic valve 1218 may be configured as the inverter of FIGS. 9A and 9B. A first port 1222 of second fluidic valve 1218 may be coupled to a high-pressure source and a base port 1224 of second fluidic valve 1218 may be coupled to a low-pressure drain. When gate port 1226 of second fluidic valve 1218 receives high pressure from second port 1220 of first fluidic valve 1216, second port 1220 (O) of second fluidic valve 1218 may be coupled to the low pressure of base port 1224. When gate port 1226 of second fluidic valve 1218 is coupled to low pressure from second port 1220 of first fluidic valve 1216, second port 1220 (O) of second fluidic valve 1218 may be coupled to the high pressure of first port 1222. In some examples, NOR gate 1200 may be part of a fluidic valve combinatorial logic circuit and provide a logical NOR function for the logic circuit.

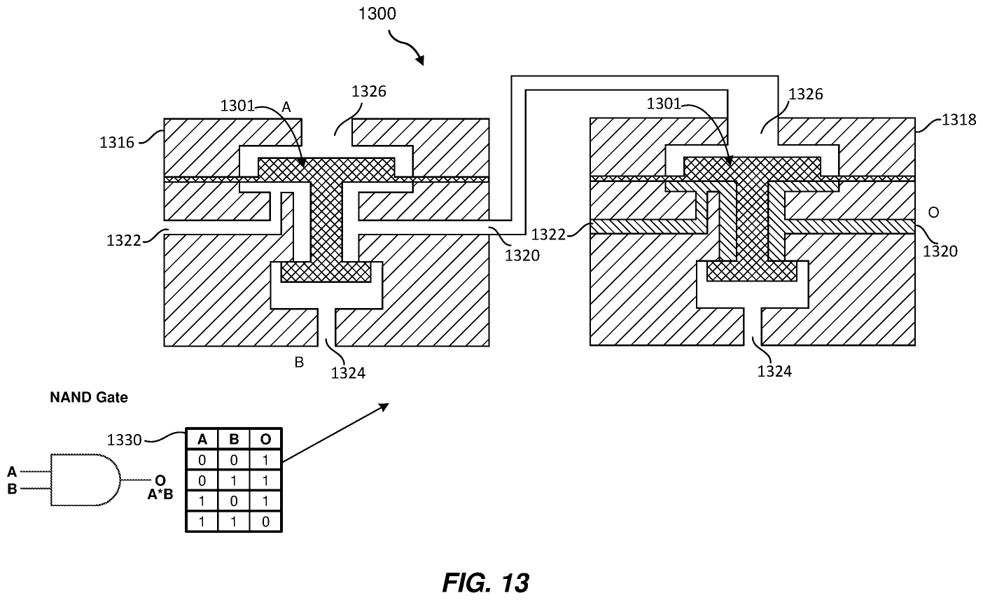

FIG. 13 is a cross-sectional view of an example NAND fluidic logic-gate device 1300 (NAND gate), according to at least one embodiment of the present disclosure. NAND gate 1300 may include a first fluidic valve 1316 (left side fluidic valve as viewed from the perspective of FIG. 13) and a second fluidic valve 1318 (right side fluidic valve as viewed from the perspective of FIG. 13). First fluidic valve 1316 and second fluidic valve 1318 may include fluidic valve 500 described with reference to FIG. 5. First fluidic valve 1316 may be configured as the AND gate of FIGS. 11A-11D and second fluidic valve 1318 may be configured as the inverter of FIGS. 9A and 9B. First fluidic valve 1216 may include a first port 1322 coupled to a low-pressure drain (e.g., atmospheric pressure). A base port 1324 (labeled B in FIG. 13) and a gate port 1326 (labeled A in FIG. 13) may receive fluid inputs that include a high pressure (logic 1) or a low pressure (logic 0). A second port 1320 of first fluidic valve 1316 may be inverted by second fluidic valve 1318. Second port 1320 of first fluidic valve 1316 may be fluidically coupled to a gate port 1326 of second fluidic valve 1318. A first port 1322 of second fluidic valve 1318 may be coupled to a high-pressure source and a base port 1324 of second fluidic valve 1318 may be coupled to a low-pressure drain (e.g., atmospheric pressure). A second port 1320 (labeled O in FIG. 13) may be an output of NAND gate 1300. NAND gate 1300 may operate according to the logic truth table 1330 shown in FIG. 13.

Corresponding to the first row of logic table 1330, when both gate port 1326 and base port 1324 of first fluidic valve 1316 are coupled to a low pressure (logic 0), the elastomeric properties of piston 1301 may cause piston 1301 to form into a shape that moves piston 1301 to the upward position (as viewed from the perspective of FIG. 13) and open a fluid path between first port 1322 and second port 1320 of first fluidic valve 1316, coupling the low-pressure drain to second port 1320. Corresponding to the second row of logic table 1330, when gate port 1326 of first fluidic valve 1316 is coupled to a low pressure (logic 0) and base port 1324 of first fluidic valve 1316 is coupled to a high pressure (logic 1), the high pressure may apply a force to the bottom of piston 1301 causing the piston to move (or remain) in an upwards direction (as viewed from the perspective of FIG. 13) and open a fluid path between first port 1322 and second port 1320 of first fluidic valve 1316, coupling the low pressure to second port 1320 of first fluidic valve 1316.

Corresponding to the third row of logic table 1330, when gate port 1326 of first fluidic valve 1316 is coupled to a high pressure (logic 1) and base port 1324 of first fluidic valve 1316 is coupled to a low pressure (logic 0), the high pressure on gate port 1326 may apply a force to the top of piston 1301 causing piston 1301 to move in a downwards direction (as viewed from the perspective of FIG. 13) and open a fluid path between base port 1324 and second port 1320 of first fluidic valve 1316, coupling the low pressure to second port 1320 of first fluidic valve 1316. Corresponding to the last row of logic table 1330, when gate port 1326 and base port 1324 of first fluidic valve 1316 are coupled to a high pressure (logic 1), the high pressure may create a net force on the top of piston 1301 causing piston 1301 to move in a downwards direction (as viewed from the perspective of FIG. 13) and open a fluid path between base port 1324 and second port 1320, coupling the high pressure to second port 1320 of first fluidic valve 1316.

As noted above, second port 1320 of first fluidic valve 1316 may be fluidically coupled to a gate port 1326 of second fluidic valve 1318. Second fluidic valve 1318 may be configured as the inverter of FIGS. 9A-9B. A first port 1322 of second fluidic valve 1318 may be coupled to a high-pressure source and a base port 1324 of second fluidic valve 1318 may be coupled to a low-pressure drain (e.g., atmospheric pressure). When gate port 1326 of second fluidic valve 1318 receives high pressure from second port 1320 of first fluidic valve 1316, a second port 1320 (O) of second fluidic valve 1318 may be coupled to the low pressure of base port 1324. When gate port 1326 of second fluidic valve 1318 receives low pressure from second port 1320 of first fluidic valve 1316, second port 1320 (O) of second fluidic valve 1318 may be coupled to the high pressure of first port 1322. In some examples, NAND gate 1300 may be part of a fluidic valve combinatorial logic circuit and provide a logical NAND function for the logic circuit.

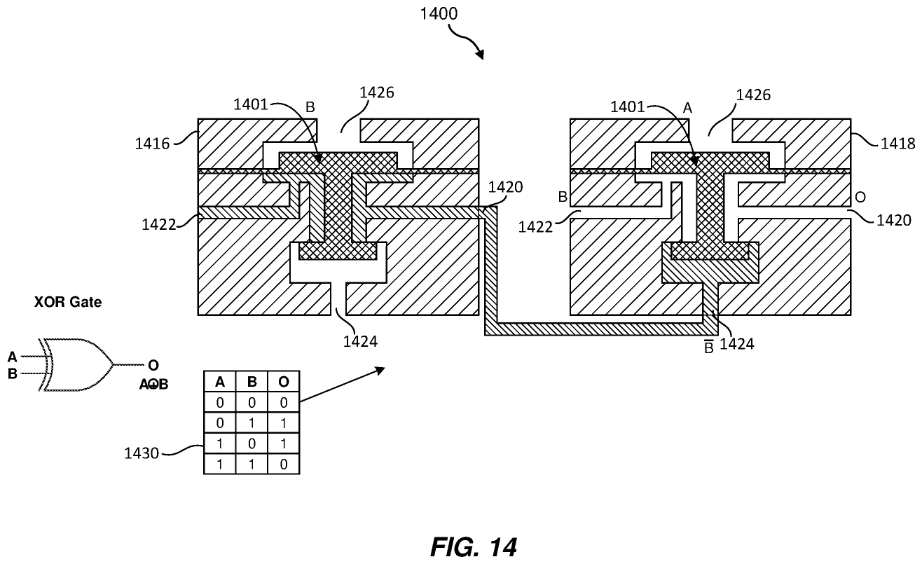

FIG. 14 is a cross-sectional view of an example XOR (exclusive or) fluidic logic-gate device 1400 (XOR gate), according to at least one embodiment of the present disclosure. XOR gate 1400 may include a first fluidic valve 1416 (left side fluidic valve as viewed from the perspective of FIG. 14) and a second fluidic valve 1418 (right side fluidic valve as viewed from the perspective of FIG. 14). First fluidic valve 1416 and second fluidic valve 1418 may each include fluidic valve 500 described with reference to FIG. 5. First fluidic valve 1416 may include a first port 1422 coupled to a high-pressure source. A base port 1424 of first fluidic valve 1416 may be coupled to a low-pressure drain. A gate port 1426 (labeled B in FIG. 14) of first fluidic valve 1416 and a gate port 1426 (labeled A in FIG. 14) of second fluidic valve 1418 may receive fluid inputs that exhibit a high pressure (logic 1) or a low pressure (logic 0). A second port 1420 of first fluidic valve 1416 may be coupled to a base port 1424 (labeled B in FIG. 14) of second fluidic valve 1418. Base port 1424 of second fluidic valve 1418 may be configured to exhibit an inverted fluidic signal relative to gate port 1426 of first fluidic valve 1416. Although not shown in FIG. 14, gate port 1426 (B) of first fluidic valve 1416 may be coupled to first port 1422 of second fluidic valve 1418. A second port 1420 (labeled O in FIG. 14) may be an output of XOR gate 1400. XOR gate 1400 may operate according to the logic truth table 1430 shown in FIG. 14.

Corresponding to the first row of truth table 1430, when both gate port 1426 (A) of second fluidic valve 1418 and gate port 1426 (B) of first fluidic valve 1416 are coupled to a low pressure (logic 0), high pressure from first port 1422 may apply a force to the underside region of piston 1401 that moves piston 1401 of first fluidic valve 1416 to an upward position (as viewed from the perspective of FIG. 14) and couples the high pressure to second port 1420 of first fluidic valve 1416 and base port 1424 of second fluidic valve 1418. High pressure on base port 1424 (B) may apply a force to the bottom of piston 1401 of second fluidic valve 1418 that moves piston 1401 to an upward position (as viewed from the perspective of FIG. 14) and couples the low pressure on first port 1422 (B) of second fluidic valve 1418 to a second port 1420 (O) of second fluidic valve 1418.

Corresponding to the second row of truth table 1430, when gate port 1426 (A) of second fluidic valve 1418 is coupled to a low pressure (logic 0) and gate port 1426 (B) of first fluidic valve 1416 is coupled to a high pressure (logic 1), the elastomeric properties of piston 1401 of second fluidic valve 1418 may cause piston 1401 to form into a shape that moves piston 1401 to the upward position (as viewed from the perspective of FIG. 14) and opens a fluid path between first port 1422 and second port 1420 of first fluidic valve 1416, coupling the high pressure on first port 1422 (B) to second port 1420 (O) of second fluidic valve 1418.

Corresponding to the third column of truth table 1430, when gate port 1426 (A) of second fluidic valve 1418 is coupled to a high pressure (logic 1) and gate port 1426 (B) of first fluidic valve 1416 is coupled to a low pressure (logic 0), high pressure on first port 1422 of first fluidic valve 1416 may apply a force to the underside region of piston 1401 that moves piston 1401 of first fluidic valve 1416 to an upward position (as viewed from the perspective of FIG. 14) and couples the high pressure to second port 1420 of first fluidic valve 1416 and base port 1424 of second fluidic valve 1418. High pressure on gate port 1426 (A) of second fluidic valve 1418 may force piston 1401 on second fluidic valve 1418 downward, opening a path from base port 1424 to second port 1420 (O) of second fluidic valve 1418 and couple the high pressure to second port 1420 (O) of second fluidic valve 1418.

Corresponding to the last row in truth table 1430, when gate port 1426 (A) of second fluidic valve 1418 and gate port 1426 (B) of first fluidic valve 1416 are coupled to a high pressure (logic 1), the high pressure may force pistons 1401 of first fluidic valve 1416 and second fluidic valve 1418 downward (as viewed from the perspective of FIG. 14) creating a fluid path from base port 1424 to second port 1420 on first fluidic valve 1416 and base port 1424 of second fluidic valve 1418. The high pressure on piston 1401 of second fluidic valve 1418 may create a fluid path from base port 1424 to second port 1420 (O) of second fluidic valve 1418, coupling the low pressure to second port 1420 (O) of second fluidic valve 1418. In some examples, XOR gate 1400 may be part of a fluidic valve combinatorial logic circuit and provide a logical XOR function for the logic circuit.

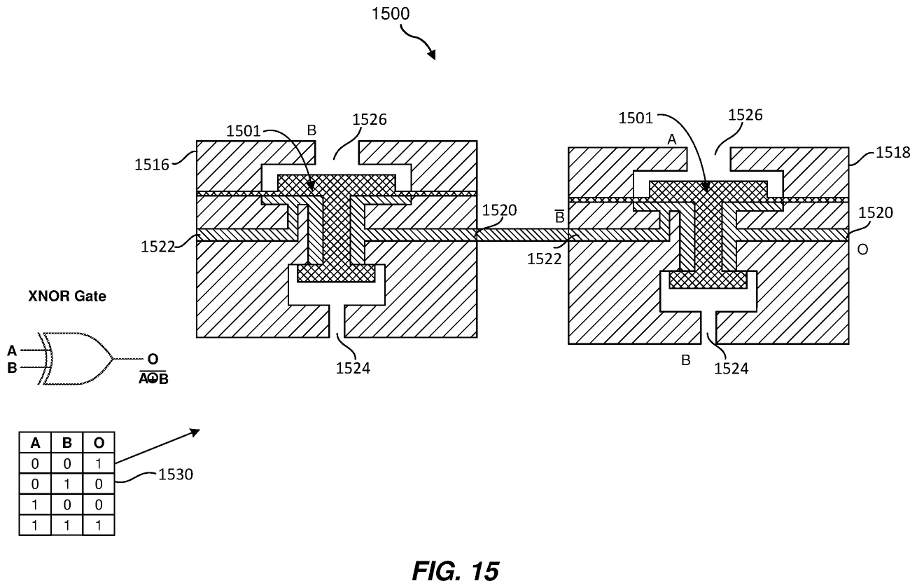

FIG. 15 is a cross-sectional view of an example XNOR fluidic logic-gate device 1500 (XNOR gate), according to at least one embodiment of the present disclosure. XNOR gate 1500 may include a first fluidic valve 1516 (e.g., the left side fluidic valve as viewed from the perspective of FIG. 15) and a second fluidic valve 1518 (e.g., the right side fluidic valve as viewed from the perspective of FIG. 15). First fluidic valve 1516 and second fluidic valve 1518 may include fluidic valve 500 described with reference to FIG. 5. First fluidic valve 1516 may include a first port 1522 coupled to a high-pressure source. A base port 1524 of first fluidic valve 1516 may be coupled to a low-pressure drain. A gate port 1526 (labeled B in FIG. 15) of first fluidic valve 1516 and a gate port 1526 (labeled A in FIG. 15) of a second fluidic valve 1518 may receive fluid inputs that exhibit a high pressure source (logic 1) or a low-pressure drain (logic 0). A second port 1520 of first fluidic valve 1516 may be coupled to a first port 1522 (labeled B in FIG. 15) of second fluidic valve 1518. Although not shown in FIG. 15, gate port 1526 (labeled B in FIG. 15) of first fluidic valve 1516 may be fluidically coupled to a base port 1524 (also labeled B in FIG. 15) of second fluidic valve 1518. A second port 1520 (labeled O in FIG. 15) may be an output of XNOR gate 1500. XNOR gate 1500 may operate according to the logic truth table 1530 shown in FIG. 15.

Corresponding to the first row of truth table 1530, when both gate port 1526 (A) of second fluidic valve 1518 and gate port 1526 (B) of first fluidic valve 1516 (connected to base port 1524 of second fluidic valve 1518) are coupled to a low pressure (logic 0), high pressure on first port 1522 of first fluidic valve 1516 may apply a force to the underside region of piston 1501 that moves piston 1501 of first fluidic valve 1516 to an upward position (as viewed from the perspective of FIG. 15) and couple the high pressure to second port 1520 of first fluidic valve 1516 and first port 1522 (B̅) of second fluidic valve 1518. High pressure on first port 1522 (B̅) may apply a force to the underside region of piston 1501 of second fluidic valve 1518 that moves piston 1501 to an upward position (as viewed from the perspective of FIG. 15) and couples the high pressure on first port 1522 (B̅) of second fluidic valve 1518 to second port 1520 (O) of second fluidic valve 1518.

Corresponding to the second row of truth table 1530, when gate port 1526 (A) of second fluidic valve 1518 is coupled to a low pressure (logic 0) and gate port 1526 (B) of first fluidic valve 1516 is coupled to a high pressure (logic 1), the high pressure on gate port 1526 (B) of first fluidic valve 1516 may force the piston 1501 of first fluidic valve 1516 to a downward position (as viewed from the perspective of FIG. 15) creating a flow path from base port 1524 to second port 1520 of first fluidic valve 1516 and couple the low pressure to second port 1520 of first fluidic valve 1516 and first port 1522 (B̅) of second fluidic valve 1518. The high pressure on base port 1524 of second fluidic valve 1528 (coupled to the B input) may cause piston 1501 of second fluidic valve 1518 to move to an upward position (as viewed from the perspective of FIG. 15) opening a fluid path between first port 1522 (B̅) and second port 1520 (O), coupling the low pressure on first port 1522 (B̅) to second port 1520 (O) of second fluidic valve 1518.

Corresponding to the third row of truth table 1530, when gate port 1526 (A) of second fluidic valve 1518 is coupled to a high pressure source (logic 1) and gate port 1526 (B) of first fluidic valve 1516 is coupled to a low-pressure drain (logic 0), high pressure from first port 1522 of first fluidic valve 1516 may apply a force on the underside region of piston 1501 that moves piston 1501 of first fluidic valve 1516 to an upward position (as viewed from the perspective of FIG. 15) and couples the high pressure to second port 1520 of first fluidic valve 1516 and first port 1522 (B̅) of second fluidic valve 1518. High pressure on gate port 1526 (A) of second fluidic valve 1518 may force piston 1501 of second fluidic valve 1518 downward (as viewed from the perspective of FIG. 15) opening a fluid path from base port 1524 of second fluidic valve 1518 (coupled to the B input) to second port 1520 (O) of second fluidic valve 1518 and couple the low pressure to second port 1520 (O) of second fluidic valve 1518.

Corresponding to the last row of truth table 1530, when gate port 1526 (A) of second fluidic valve 1518 and gate port 1526 (B) of first fluidic valve 1516 are coupled to a high pressure (logic 1), the high pressure may force pistons 1501 of first fluidic valve 1516 and second fluidic valve 1518 downward (as viewed from the perspective of FIG. 15) creating a fluid path from the low-pressure drain on base port 1524 to second port 1520 of first fluidic valve 1516. The high pressure on piston 1501 of second fluidic valve 1518 may create a fluid path from base port 1524 of second fluidic valve 1518 (coupled to the B input) to second port 1520 (O) of second fluidic valve 1518 coupling the high pressure to second port 1520 (O) of second fluidic valve 1518. In some examples, XNOR gate 1500 may be part of a fluidic valve combinatorial logic circuit and provide a logical XNOR function for the logic circuit.

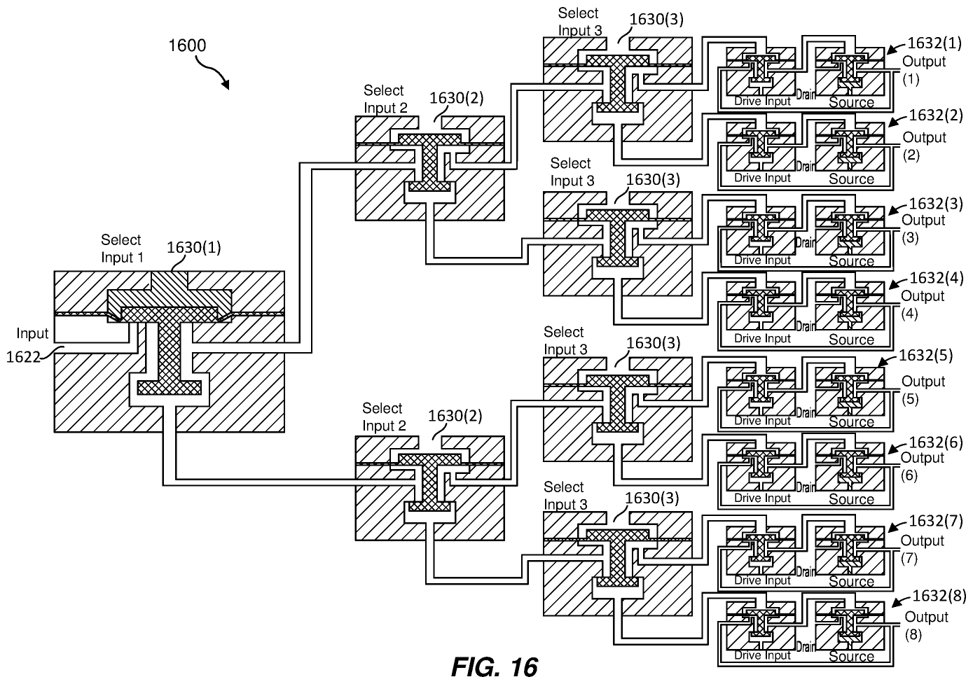

FIG. 16 is a cross-sectional view of an example fluidic demultiplexer device 1600, according to at least one embodiment of the present disclosure. Fluidic demultiplexer device 1600 (also referred to herein as “demux 1600”) may include a plurality of fluidic valves 500 described above with reference to FIG. 5. The fluidic valves of demux 1600 may be fluidically coupled to one another as shown in FIG. 16. Demux 1600 may include a first port 1622 (e.g., an input port) that is fluidically coupled to one of 2^{N} control gates (e.g., output latches) based on the pressure states of N select ports. The example demux 1600 of FIG. 16 shows an embodiment of N=3, where 3 select ports 1630 (1) . . . 1630 (3) may be configured to select one of eight output latches 1632 (1) . . . 1632 (8). However, the present embodiment is not so limited and any number of select ports 1630 and any number of output latches 1632 may be used.

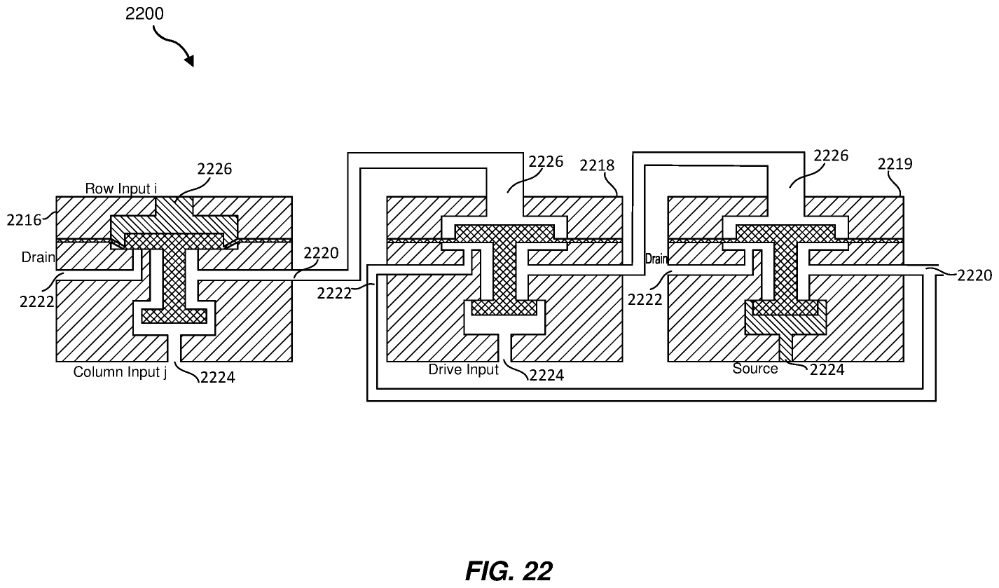

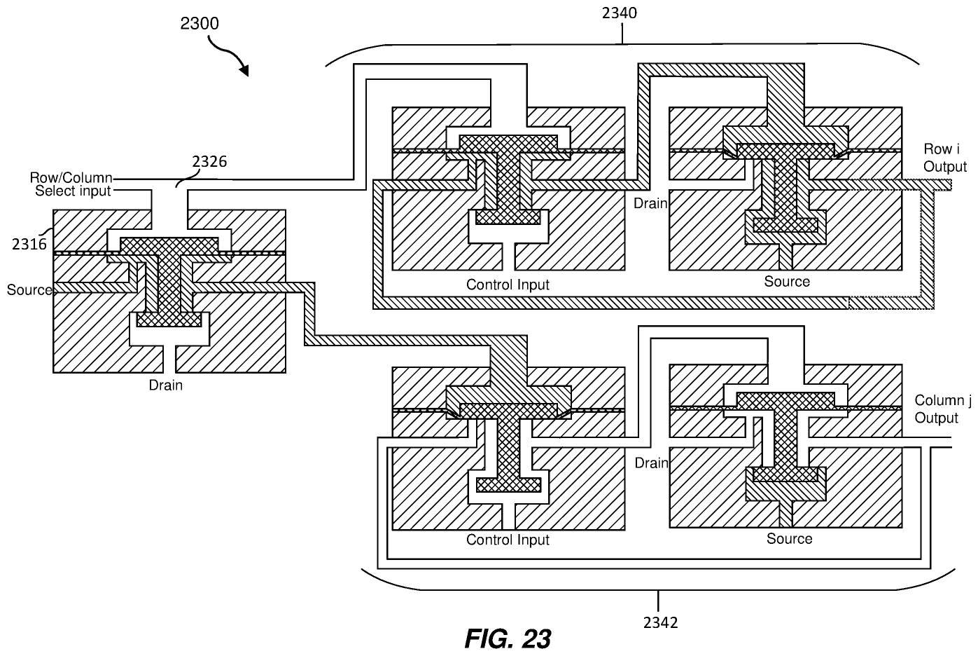

Select ports 1630 (1) . . . 1630 (3) may be configured as gate ports (e.g., gate port 526 as described above with reference to FIG. 5) and may be used to apply a high pressure (logic 1) or a low pressure (logic 0) to the gate portion (e.g., gate portion 508 as described above with reference to FIG. 5) of the piston (e.g., piston 501 as described above with reference to FIG. 5) disposed in the top center area of the piston. Each combination of high and low pressure on select ports 1630 (1) . . . 1630 (3) may block or unblock fluid paths in demux 1600 fluid circuit to create a unique fluid path from first port 1622 to one of output latches 1632 (1) . . . 1632 (8). The combination of pressure inputs on select ports 1630 (1) . . . 1630 (3) may select one of output latches 1632 (1) . . . 1632 (8). Each of output latches 1632 (1) . . . 1632 (8) may include a drive input port. The drive input port may be at a high pressure or a low pressure and may be configured (e.g., connected) as a common input to each of output latches 1632 (1) . . . 1632 (8). The drive input pressure (high pressure or low pressure) may be conveyed to one of output (1) . . . output (8) of the selected latch based on the unique combination of select ports 1630 (1) . . . 1630 (3). Each of output latches 1632 (1) . . . 1632 (8) may include a latch as described below with reference to FIGS. 22 and 23.

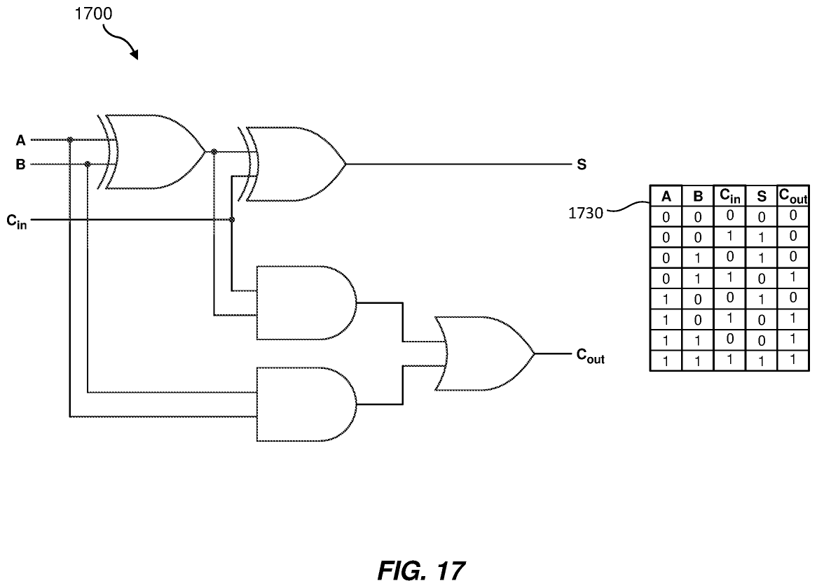

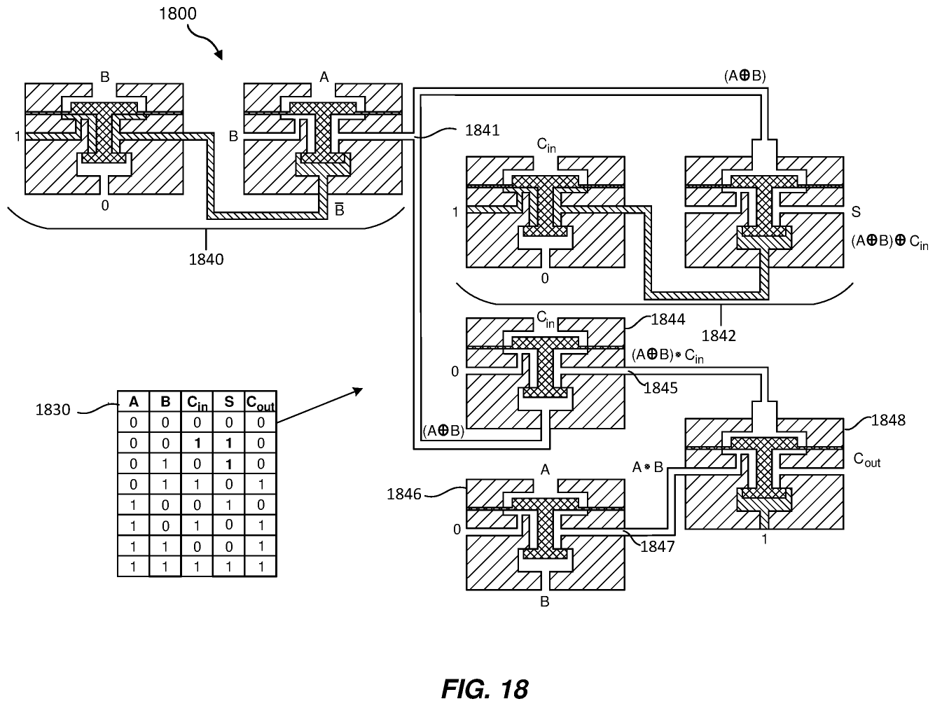

FIG. 17 illustrates a logic diagram 1700 and a truth table 1730 for a fluidic full adder device (e.g., full adder 1800 of FIG. 18), according to at least one embodiment of the present disclosure. Logic diagram 1700 shows combinatorial logic gates for a full adder that receives a first binary input A, a second binary input B, and a carry-in input Cᵢₙ. Logic diagram 1700 may function according to truth table 1730 and provides an output S that is the arithmetic sum of sum of first binary input A, second binary input B, and carry-in input Cᵢₙ. Logic diagram 1700 may also function to provide an arithmetic carry-out Cₒᵤₜ of first binary input A, second binary input B, and carry-in input Cᵢₙ. Each binary fluidic input may be represented by a high-pressure state or a low-pressure state.

Logic diagram 1700 of the fluidic full adder device may be implemented by a fluidic logic circuit using fluidic valves 500 described in reference to FIG. 5. For example, the fluidic full adder device may be implemented by the embodiment described with reference to FIG. 18 below. Additionally or alternatively, the fluidic full adder device may be cascaded to produce adders of any number of binary fluidic inputs by daisy-chaining carry-out Cₒᵤₜ of one full adder to carry-in C₁₀ of the adjacent full adder. In some examples, the fluidic full adder may be used to create a fluidic arithmetic logic unit and may be used for fluid arithmetic to calculate addresses, table indices, increment and decrement operators, and similar logic and/or computational operations.

FIG. 18 is a cross-sectional view of an example fluidic full adder device 1800 (also referred to as “full adder 1800”), according to at least one embodiment of the present disclosure. Full adder 1800 may be configured according to truth table 1830 of FIG. 18 and may include a plurality of fluidic valves 500 described above with reference to FIG. 5. Full adder 1800 may include a first XOR gate 1840 (e.g., XOR fluidic logic-gate device 1400 of FIG. 14) that is configured to receive a first binary fluidic input A and a second binary fluidic input B (high pressure or low pressure), and produce a logical exclusive OR function thereof at a first output 1841 of first XOR gate 1840. Full adder 1800 may include a second XOR gate 1842 that is configured to receive first output 1841 and a carry-in input C₁₀ and produce a logical exclusive OR function thereof at a second output (labeled S in FIG. 18) of second XOR gate 1842 that is representative of an arithmetic sum S of A, B, and C₁₀ binary fluidic inputs. Full adder 1800 may include a first AND gate 1844 (e.g., AND fluidic logic-gate device 1100 of FIGS. 11A-11D) that is configured to receive first output 1841 and carry-in input C₁₀ binary fluidic inputs and produce a logical AND function thereof at a third output 1845 of AND gate 1844.

Full adder 1800 may include a second AND gate 1846 that is configured to receive first input A and second input B and produce a logical AND function thereof at a fourth output 1847 from second AND gate 1846. Full adder 1800 may include an OR gate 1848 (e.g., OR fluidic logic-gate device 1000 of FIG. 10) that is configured to receive third output 1845 and fourth output 1847, respectively, and produce a logical OR function thereof at a carry output Cₒᵤₜ of OR gate 1848 that is representative of an arithmetic carry of first input A, second input B, and carry-in input Cᵢₙ. In some examples, full adder 1800 may be part of a fluidic valve sequential and/combinatorial logic circuit and provide an arithmetic adding function for the logic circuit.

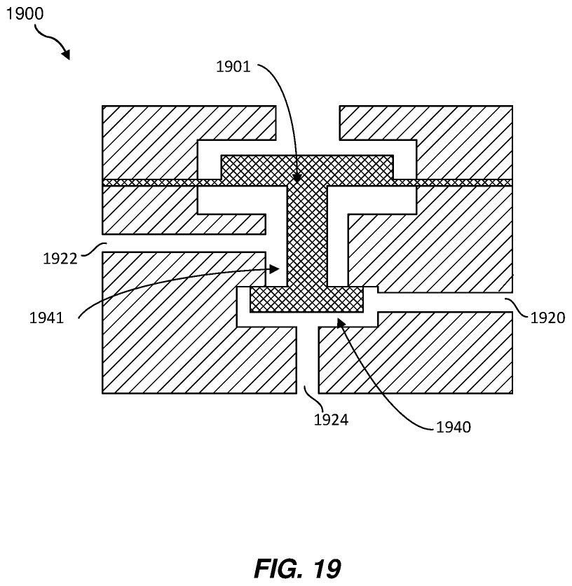

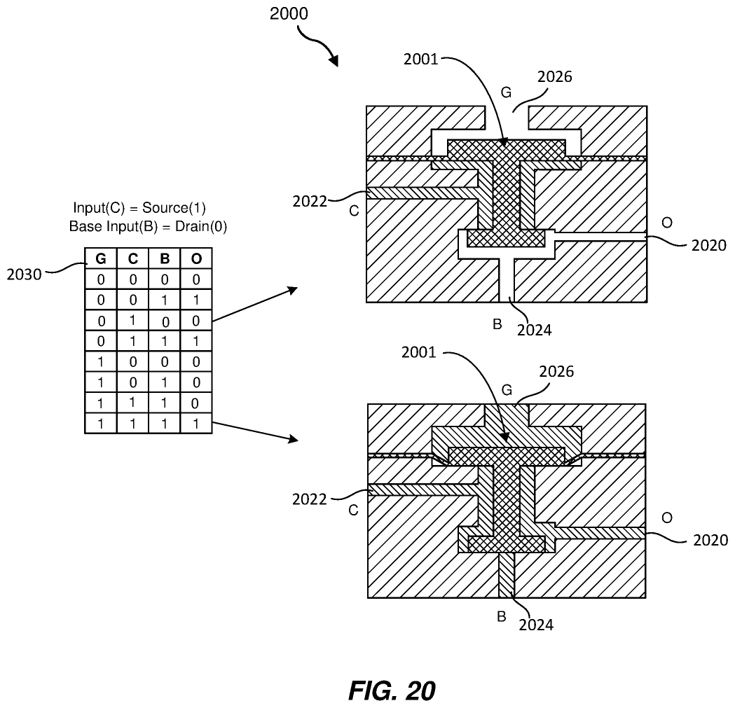

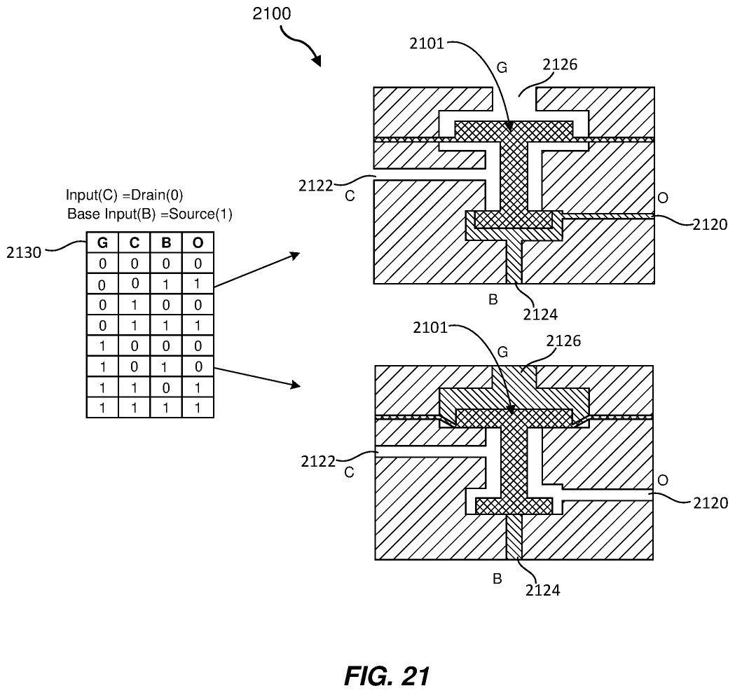

FIG. 19 is a cross-sectional view of an alternative configuration of a fluidic valve 1900, according to at least one embodiment of the present disclosure. As compared to fluidic valve 500 of FIG. 5, fluidic valve 1900 may have a second port 1920 and a base port 1924 positioned and configured to be fluidically coupled to a chamber 1940 within which the lower base portion of piston 1901 resides. Fluidic valve 1900 may also have a first port 1922 positioned and configured to be fluidically coupled to a chamber 1941 within which a central column of piston 1901 resides. When piston 1901 is in an up position (as shown in FIG. 19), base port 1924 and second port 1920 may be in fluid communication. When piston 1901 is in a down position, first port 1922 and second port 1920 may be in fluid communication. Fluidic valve 1900 may be operated as a buffer gate as described below with reference to FIG. 20 and/or an inverter gate as described below with reference to FIG. 21.

FIG. 20 is a cross-sectional view of an alternative configuration of a fluidic valve buffer 2000 (also referred to as “alternative buffer 2000”), according to at least one embodiment of the present disclosure. Alternative buffer 2000 may include the alternative configuration fluidic valve 1900 described above with reference to FIG. 19. Alternative buffer 2000 may include a first port 2022 coupled to a pressurized source while a base port 2024 is coupled to a low-pressure drain (e.g., open to atmospheric pressure). Alternative buffer 2000 may operate according to a truth table 2030. When a gate port 2026 is pressurized, a piston 2001 may move in a downwards direction (as viewed from the perspective of FIG. 20) and may open a fluid path between first port 2022 and a second port 2020, coupling the pressurized fluid to second port 2020. When gate port 2026 is not pressurized (e.g., coupled to a pressure drain), the source pressure in first port 2022 may apply a force to the underside region of piston 2001 causing the piston to move in an upwards direction (as viewed from the perspective of FIG. 20) and open a fluid path between base port 2024 and second port 2020, coupling the low pressure of base port 2024 to second port 2020. In some examples, Alternative buffer 2000 may mirror the state of gate port 2026 onto the state of second port 2020 while providing a different (e.g., higher or lower) fluid pressure and/or different fluid flow rate than is provided by the fluid at gate port 2026.

FIG. 21 is a cross-sectional view of an alternative configuration of a fluidic valve inverter 2100 (also referred to as “alternative inverter 2100”), according to at least one embodiment of the present disclosure. Alternative inverter 2100 may include a base port 2124 coupled to a high pressure while a first port 2122 is coupled to a low-pressure drain (e.g., open to atmospheric pressure). Alternative inverter 2100 may operate according to a truth table 2130. When a gate port 2126 is pressurized, a piston 1201 may move in a downwards direction (as viewed from the perspective of FIG. 21) and open a fluid path between first port 2122 and a second port 2120, coupling the low pressure from first port 2122 to second port 2120.

When gate port 2126 is not pressurized (e.g., connected to a pressure drain), high pressure on base port 2124 may apply a force to the bottom of piston 2101 causing piston 2101 to move in an upwards direction (as viewed from the perspective of FIG. 21) and open a fluid path between base port 2124 and second port 2120, coupling the high-pressure fluid of base port 2124 to second port 2120. Alternative inverter 2100 may mirror an inverted pressure state of gate port 2126 onto the pressure state of second port 2120. In some examples, alternative inverter 2100 may be part of a fluidic valve combinatorial logic circuit and provide an inverting function for the logic circuit.

FIG. 22 is a cross-sectional view of an example fluidic row column buffered latch decode device 2200 (also referred to as “buffered latch decoder 2200”), according to at least one embodiment of the present disclosure. Buffered latch decoder 2200 may be configured to convert N pressure inputs (e.g., inputs from the piezo valves 700 of FIG. 7) into (N−2)² pressure outputs. The piezo valves may be configured to provide a source of high-pressure fluid to a larger number of pressure outputs through buffered latch decoder 2200. Buffered latch decoder 2200 may include a first fluidic valve 2216, a second fluidic valve 2218, and a third fluidic valve 2219. First fluidic valve 2216, second fluidic valve 2218, and third fluidic valve 2219 may include fluidic valve 500 as described above with reference to FIG. 5. First fluidic valve 2216 may be configured as an AND gate as described above with reference to FIGS. 11A-11D. Third fluidic valve 2219 may be configured as a buffer as described with reference to FIGS. 8A and 8B. A first port 2222 of first fluidic valve 2216 may be coupled to a pressure drain (e.g., open to atmosphere).

A second port 2220 of first fluidic valve 2216 may be configured to operate according to logic truth table 1130 of FIG. 11E and may only be coupled to high pressure when both row input i (connected to gate port 2226) and column input j (connected to base port 2224) of first fluidic valve 2216 are at a high-pressure state. Second port 2220 of first fluidic valve 2216 may be coupled to a gate port 2226 of second fluidic valve 2218. Third fluidic valve 2219 may be configured as a buffer and its second port 2220 may mirror the pressure state (high-pressure or low-pressure) of a gate port 2226 of third fluidic valve 2219. Second port 2220 of third fluidic valve 2219 may be fluidically coupled to (e.g., fed back to) a first port 2222 of second fluidic valve 2218 allowing high-pressure flow through second fluidic valve 2218 to gate port 2226 of third fluidic valve 2219 and latching the state of second port 2220 of third fluidic valve 2219. When gate port 2226 of second fluidic valve 2228 is pressurized (e.g., when both the row input i and the column input j are high pressure), base port 2224 (e.g., a drive input) of second fluidic valve 2218 may be coupled to gate port 2226 of third fluidic valve 2219 allowing second port 2220 of third fluidic valve 2219 to mirror the pressure state of base port 2224 (e.g., a drive input). When either the row i or column input j to first fluidic valve 2216 is low pressure, second port 2220 of third fluidic valve 2219 will remain latched in the same pressure state due to the fluidic feedback.

By latching second port 2220 (e.g., the output) of third fluidic valve 2219 (e.g., a buffer), third fluidic valve 2219 may be configured to provide a continuous high-pressure fluid or a low-pressure fluid to a device (e.g., an inflatable bladder) that is fluidically coupled to second port 2220 of third fluidic valve 2219. By cascading the fluid circuit of FIG. 22 (e.g., creating an array addressable by row i and column j), each second port 2220 of third fluidic valve 2219 may be addressed by the row i and column j inputs.

FIG. 23 is a cross-sectional view of an example fluidic row-column demultiplexer device 2300, according to at least one embodiment of the present disclosure. In some embodiments, demultiplexer device 2300 may be configured to be used in conjunction with buffered latch decoder 2200 of FIG. 22. Buffered latch decoder 2200 of FIG. 22 may include X row inputs (e.g., 6 row inputs) and X column inputs (e.g., 6 column inputs). In order to reduce the total number of inputs, demultiplexer device 2300 may be configured to include X inputs for both row i and column j inputs with a select input connected to gate port 2326 of fluidic valve 2316 that toggles between the selected row i and the selected column j. Demultiplexer device 2300 may include a first buffered latch 2340 (e.g., buffered latch decoder 2200 of FIG. 22) for latching the control input onto the row i output and a second buffered latch 2342 for latching the control input onto the column j output. The ports of fluidic valve 2316, first buffered latch 2340, and second buffered latch 2342 may be connected to a pressure source, a pressure drain, or interconnected to one another as shown in FIG. 23.

A single control input connected to base ports of first buffered latch 2340 and second buffered latch 2342 representing the row i or the column j (depending on the state of the row/column select input) may be configured as shown in FIG. 23. When the row/column select input is at a low pressure, second buffered latch 2342 may be selected and the control input may be latched onto the output of the second buffered latch 2342 labeled column j. When the row/column select input is at a low pressure, first buffered latch 2340 may be deselected by fluidic valve 2316. Fluidic valve 2316 may be configured as fluidic valve inverter 900 of FIGS. 9A-9B. When the select input is high pressure, first buffered latch 2340 may be selected and the control input may be latched onto the output of first buffered latch 2340 labeled row i output. When the select input is high pressure, second buffered latch 2342 may be deselected by fluidic valve 2316 configured as an inverter valve. In some examples, demultiplexer device 2300 may reduce the complexity of a fluidic integrated circuit by reducing (e.g., reducing by one half) the number of row/column inputs needed to address an array of fluid devices (e.g., inflatable bladders, fluidic haptic actuators, etc.).

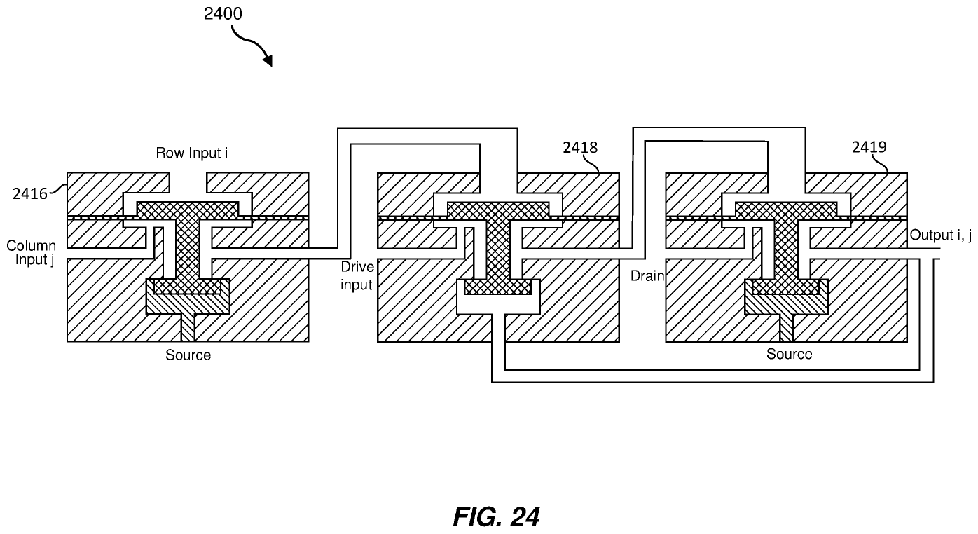

FIG. 24 is a cross-sectional view of an example fluidic row-column inverted buffered latch decode device 2400 (also referred to as “inverted buffered latch decoder 2400”), according to at least one embodiment of the present disclosure. Inverted buffered latch decoder 2400 may be configured to convert N pressure inputs (e.g., N pressure inputs from the piezo valves of FIG. 7) into (N−2)² pressure outputs. The piezo valves may be configured to provide a source of high-pressure fluid to a larger number of pressure outputs through inverted buffered latch decoder 2400. Inverted buffered latch decoder 2400 may be configured similarly to buffered latch decoder 2200 of FIG. 22 but using an OR gate instead of an AND gate and providing a different feedback path for latching the output. Inverted buffered latch decoder 2400 may include a first fluidic valve 2416, a second fluidic valve 2418, and a third fluidic valve 2419. Each of first fluidic valve 2416, second fluidic valve 2418, and third fluidic valve 2419 may include fluidic valve 500 described above with reference to FIG. 5. The ports of first fluidic valve 2416, second fluidic valve 2418, and third fluidic valve 2419 may be connected to a pressure source, a pressure drain, or interconnected to one another as shown in FIG. 24.

First fluidic valve 2416 may be configured as an OR gate as described above with reference to FIGS. 10A-10D. Third fluidic valve 2419 may be configured as a buffer described above with reference to FIGS. 8A and 8B. The output of first fluidic valve 2416 may operate according the truth table 1030 of FIG. 10E and may be coupled to high pressure when either the row input i or the column input j are high pressure. The output of first fluidic valve 2416 may be coupled to the gate port of second fluidic valve 2418. Third fluidic valve 2419 may be configured as a buffer and its output i, j may mirror the pressure state (high-pressure or low-pressure) of the gate port of third fluidic valve 2419. Output i, j of third fluidic valve 2419 may be fluidically coupled to (e.g., fed back to) the base port of second fluidic valve 2418 allowing high-pressure flow through second fluidic valve 2418 to the gate port of third fluidic valve 2419, thereby latching output i, j of third fluidic valve 2419. When the gate port of second fluidic valve 2418 is not pressurized (e.g., when row input i and column input j are low pressure), the drive input of second fluidic valve 2418 may be coupled to the gate input of third fluidic valve 2419 allowing output i, j of third fluidic valve 2419 to mirror the pressure state of the drive input.

By latching output i, j of third fluidic valve 2419 (e.g., a buffer), third fluidic valve 2419 may be configured to provide a continuous high-pressure fluid or a continuous low-pressure fluid to a device (e.g., an inflatable bladder) that is fluidically coupled to output i, j. By cascading the fluid circuit of FIG. 24 (e.g., creating an array addressable by row i and column j), each output i, j of third fluidic valve 2419 may be addressed by row i and column j inputs.

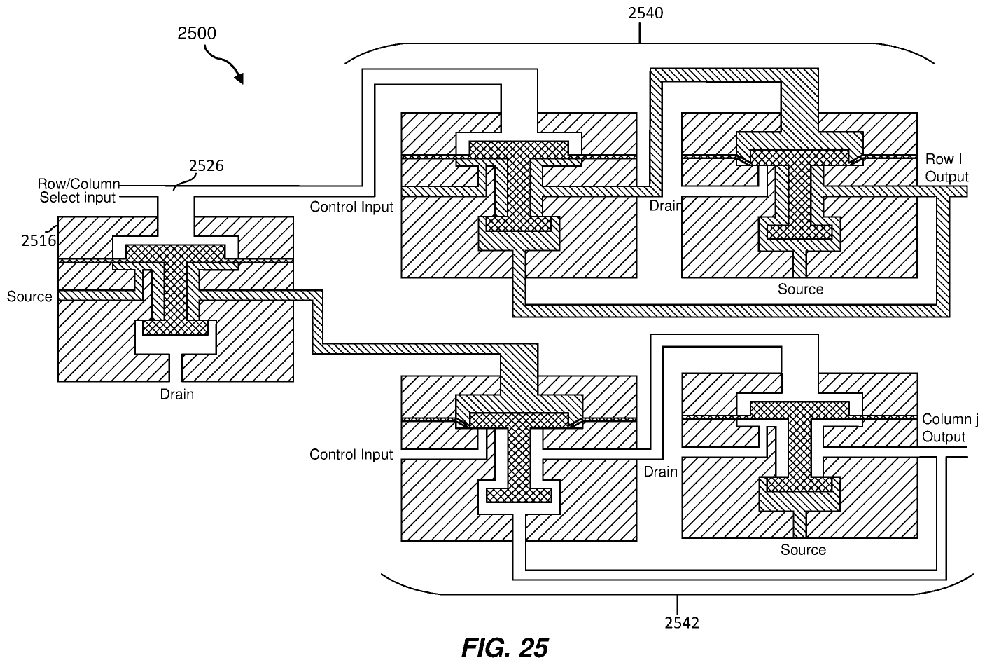

FIG. 25 is a cross-sectional view of an example fluidic row-column inverted demultiplexer device 2500, according to at least one embodiment of the present disclosure. Inverted demultiplexer device 2500 may be configured to be used in conjunction with buffered latch decoder 2200 of FIG. 22. Buffered latch decoder 2200 of FIG. 22 may include X row inputs (e.g., 6 row inputs) and X column inputs (e.g., 6 column inputs). In order to reduce the total number of inputs, inverted demultiplexer device 2500 may be configured to include X inputs for both row i and column j inputs with a row/column select input to toggle between the selected row i and the selected column j. Row i and column j inputs may be applied to gate port 2526 of fluidic valve 2516.

Inverted demultiplexer device 2500 may be configured similarly to demultiplexer device 2300 of FIG. 23 but provides a different feedback path for latching the row i and column j outputs and provides the control inputs to the first port (e.g., left port) of a first buffered latch 2540 and a second buffered latch 2542. Inverted demultiplexer device 2500 may include first buffered latch 2540 for latching the control input to the row output i and second buffered latch 2542 for latching the control input to column output j. A single control input representing the row i or the column j (depending on the state of the row/column select input) may be configured as shown in FIG. 25. The ports of fluidic valve 2516, first buffered latch 2540, and second buffered latch 2542 may be connected to a pressure source, a pressure drain, or interconnected to one another as shown in FIG. 25.

When the row/column select input is high pressure, second buffered latch 2542 (column latch) may be selected and the control input (high or low pressure) may be latched onto column j output of second buffered latch 2542. When the select input is high pressure, first buffered latch 2540 may be deselected by fluidic valve 2516 that is configured as an inverter valve (e.g., fluidic valve inverter 900 of FIGS. 9A-9B). When the row/column select input is at a low pressure, first buffered latch 2540 (row latch) may be selected and the control input (high or low pressure) may be latched onto row j output of first buffered latch 2540. When the row/column select input is at a low pressure, second buffered latch 2542 may be deselected by fluidic valve 2516. In some examples, inverted demultiplexer device 2500 may reduce the complexity of a fluidic integrated circuit by reducing (e.g., reducing by one half) the number of row/column inputs needed to address an array of fluid devices (e.g., inflatable bladders).

FIG. 26A is a schematic illustration of a linearized variable pressure regulator device 2600 (also referred to as “linear regulator 2600”). FIG. 26B is a chart 2602 of simulated pressure output data of linearized variable pressure regulator device 2600, according to at least one embodiment of the present disclosure. FIG. 26C is a chart 2604 of experimental pressure output data of linearized variable pressure regulator device 2600, according to at least one embodiment of the present disclosure. While the description above with respect to FIGS. 1-25 refers to fluid pressures at two distinct states (high-pressure or low-pressure), FIGS. 26B and 26C are respectively charts 2602, 2604 of simulated and experimental data of linearized variable pressure regulator device 2600 that provides a variable (e.g., analog or semi-analog) fluid pressure output. The linear regulator 2600 may produce a near continuous and monotonic pressure output as shown in the charts 2602, 2604 of FIGS. 26A-26B. As described below with reference to FIG. 27, the linear regulator 2600 may be constructed of an array (e.g., an R-2R ladder as shown in FIG. 26A) of selected diameter orifices that restrict the fluid flow. By combining the fluid flow from selected different diameter orifices into a combined pressure output, a linearized variable pressure output may be achieved. Referring to FIG. 26A, discrete values of high- and low-pressure fluid may be applied to inputs a₀ . . . aₙ₋₁ to produce a variable pressure output at Pout.

FIG. 27 illustrates fluid flow restrictors 2750(1) . . . 2750(n) (e.g., selected diameter orifices) of a linearized variable pressure regulator device 2700, according to at least one embodiment of the present disclosure. Flow restrictors 2750(1) . . . 2750(n) of the linearized variable pressure regulator device 2700 may be configured as variable diameter orifices. Flow restrictors 2750(1) . . . 2750(n) may be used similarly to the resistors in an R-2R resistor ladder in an electronic digital to analog converter. Flow restrictors 2750(1) . . . 2750(n) may be similarly arranged to the resistors in an R-2R resistor ladder to create a programmable pressure regulator.

The orifices of flow restrictors 2750(1) . . . 2750(n) may be configured to compensate for non-linear effects of the pressure-to-flow relationship of fluid flow restriction orifices. Each of flow restrictors 2750(1) . . . 2750(n) may be configured with a selected diameter that results in a desired output profile (e.g., a monotonic increasing step profile (e.g., as shown in FIGS. 26B and 26C), a linear profile, etc.). Increasing the number of R/2R stages (e.g., increasing the number of flow restrictors 2750(1) . . . 2750(n)) may decrease the step size of the pressure difference between steps and create a smoother (e.g., more linear) pressure output curve. However, in some examples, the linearized variable pressure regulator device may be subject to flow leakage, requiring a flow amplifier such as the flow amplifier described with reference to FIG. 28 below.

FIG. 28 illustrates an analog fluidic push-pull amplifier circuit 2800, according to at least one embodiment of the present disclosure. In some examples, the linearized variable pressure regulator device of FIG. 27 may utilize a fluid flow amplifier to drive certain fluidic devices (e.g., actuators, haptic bladders, etc.) that require higher fluid flow than may be provided by the linearized variable pressure regulator device. Push-pull amplifier circuit 2800 may include a first fluidic valve 2816 and a second fluidic valve 2818. First fluidic valve 2816 and second fluidic valve 2818 may each include fluidic valve 500 described above with reference to FIG. 5.

Push-pull amplifier circuit 2800 may receive a variable pressure on gate port 2826 from a low-flow, high-leakage variable pressure regulator circuit and produce a high-flow, no-leakage output to volume 2860. By way of example, push-pull amplifier circuit 2800 may receive a variable pressure from the output of a variable pressure regulator device as input to gate port 2826. Volume 2860 may include a fluidic output, such as a fluid actuator (e.g., a fluid chamber, a bladder, a haptic glove bladder). When the input to gate port 2826 presents an increase in analog fluid pressure to the gates (e.g., the top of the pistons) of first fluidic valve 2816 and a second fluidic valve 2818, piston 2801 of first fluidic valve 2816 may move down (e.g., to the right as viewed from the perspective of FIG. 28) allowing fluid flow from a source pressure on base port 2824A of first fluidic valve 2816 into volume 2860 until the pressure in volume 2860 equals the input pressure.

When the pressure at the input to gate port 2826 equals the pressure in volume 2860, piston 2801 of first fluidic valve 2816 may move up (e.g., to the left as viewed from the perspective of FIG. 28), blocking the source pressure at base port 2824A from entering volume 2860. When the pressure at the input to gate port 2826 presents a decrease in analog air pressure, piston 2801 of second fluidic valve 2818 may move up (e.g., to the left as viewed from the perspective of FIG. 28) allowing fluid flow from volume 2860 to base port 2824B of second fluidic valve 2818. Base port 2824B of second fluidic valve 2818 may be connected to a pressure drain allowing the pressure in volume 2860 to decrease. The pressure in volume 2860 may decrease until the pressure in volume 2860 equals the input pressure at gate port 2826, moving piston 2801 of second fluidic valve 2818 up (e.g., to the left as viewed from the perspective of FIG. 28) and blocking base port 2824B of second fluidic valve 2818 from volume 2860. Thus, push-pull amplifier circuit 2800 may be operated to provide an output at volume 2860 at a pressure regulated by the input pressure at gate port 2826. The output at volume 2860 may have a different (e.g., lower or higher) flow rate while maintaining the same fluid pressure comparted to gate port 2826.

FIG. 29 is a perspective view of an example physical implementation of a fluidic full adder device 2900 (full adder), according to at least one embodiment of the present disclosure. Full adder 2900 may be physically implemented using any method and/or any materials. For example, full adder 2900 may be implemented as described above with reference to FIGS. 6A-6B. Full adder 2900 may include multiple layers of material (e.g., an acrylic material) that are stacked and bonded to one another. Each of the layers may include features for large scale integration of microfluidic valve circuits including, without limitation, channels, vias, ports, pistons, seals, valves, electronics, or a combination thereof. Each of the layers may be sealed and/or bonded to an adjacent layer in a manner that allows the fluid to move through the internal components of fluidic valve assembly. In some examples, each of the layers may include an acrylic material. Each of the layers may also include through holes that are positioned to line up with through holes of adjacent layers creating holes that extend though the entire assembly. In some examples, the layers may be bonded to one another by injecting a solvent (e.g., acetone) into the through holes. The injected solvent may wick between the layers of acrylic. The injected solvent may act as a gluing agent and create a bond between the acrylic layers.

Full adder 2900 may be configured to operate according to truth table 1730 of FIG. 17 and may include a plurality of fluidic valves 500 described above with reference to FIG. 5. Full adder 2900 may include a first XOR gate 2940 (e.g., XOR fluidic logic-gate device 1400 of FIG. 14) that is configured to receive a first binary fluidic input (labeled A in FIG. 29) and a second binary fluidic input (labeled B in FIG. 29) (high pressure or low pressure), respectively. The first XOR gate 2940 may produce a logical exclusive OR function at a first output of first XOR gate 2940. Full adder 2900 may also include a second XOR gate 2942 that is configured to receive the first output of the first XOR gate 2940 and a carry-in input (labeled Carry-in in FIG. 29) and to produce a logical exclusive OR function thereof at a second output (labeled Sum in FIG. 29) of second XOR gate 2942 that is representative of an arithmetic sum of A, B, and Carry-in binary fluidic inputs. Full adder 2900 may include a first AND gate 2944 (e.g., AND fluidic logic-gate device 1100 of FIGS. 11A-11D) that is configured to receive the first output and Carry-in binary fluidic inputs and produce a logical AND function thereof at a third output of AND gate 2944.

Full adder 2900 may include a second AND gate 2946 that is configured to receive first input A and second input B, respectively, and produce a logical AND function thereof at a fourth output from second AND gate 2946. Full adder 2900 may also include an OR gate 2948 (e.g., OR fluidic logic-gate device 1000 of FIG. 10) that is configured to receive the third output and the fourth output and produce a logical OR function thereof at a carry output (labeled Carry-out in FIG. 29) of OR gate 2948 that is representative of an arithmetic carry of first input A, second input B, and Carry-in binary fluidic inputs. In some examples, full adder 2900 may be part of a fluidic valve sequential and/combinatorial logic circuit and provide an arithmetic adding function for the logic circuit.

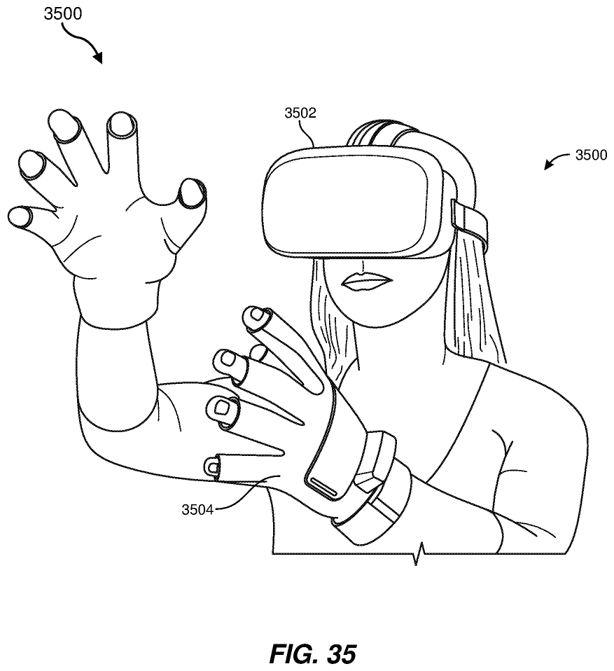

FIG. 30 is a block diagram of a microfluidic control system 3000, according to at least one embodiment of the present disclosure. Micro-fluidic control system 3000 may be configured to provide programmable fluid pressure (e.g., via air or a liquid) to an array of fluid actuators 3080 (e.g., inflatable bladders, containers, haptic feedback device, artificial-reality glove, etc.). Micro-fluidic control system 3000 may be configured to provide programmable fluid pressure to fluid actuators 3080 in an artificial-reality environment (e.g., artificial-reality environment 3500 of FIG. 35) and/or in association with an artificial-reality system (e.g., vibrotactile system 3400 of FIG. 34).

Micro-fluidic control system 3000 may include a processor 3070 that is configured to provide control signals to piezo valves 3072 (e.g., piezoelectric valves 700 of FIG. 7). Piezo valves 3072 may be configured to selectively provide a high flow rate pressure source and/or pressure drain to a decoder 3074. A fluid pressure source 3082 may be configured to provide a pressurized fluid to piezo valves 3072, decoder 3074, digital to analog converters 3076, push-pull amplifiers 3078, and/or fluid actuators 3080. Piezo valves 3072 may also be configured to drain fluid pressure to a low-pressure drain, such as atmosphere.

Decoder 3074 may be configured to receive N fluid inputs (pressure source or pressure drain) from piezo valves 3072. The N fluid inputs may be coded (e.g., binary coding) to correspond to one of 2^{N} outputs. The corresponding output (pressure source or pressure drain) decoded by decoder 3074 (e.g., demultiplexer 1600 of FIG. 16) may be latched at the output of decoder 3074 and applied as an input to digital to analog converter 3076. Multiple combinations of inputs to decoder 3074 may result in multiple combinations of pressure source and pressure drain latched on the outputs of decoder 3074. The combinations of pressure source and pressure drain inputs to digital to analog converter 3076 (e.g., a linearized variable pressure regulator device of FIGS. 26A-26C and 27) may be converted to a variable analog pressure at the output of digital to analog converter 3076. The analog pressures at the output of digital to analog converter 3076 may be provided as inputs to push-pull amplifiers 3078 (e.g., push-pull amplifier circuit 2800 of FIG. 28). Push-pull amplifiers 3078 may amplify the flow rate of the analog pressures and provide the analog fluid pressures to fluid actuators 3080. Fluid actuators 3080 may include inflatable bladders and/or fluidic haptic actuators in an artificial reality glove. In some examples, microfluidic control system 3000 may be configured to control fluid pressure and/or a flow of fluid to a bladder and/or fluidic haptic actuator in a glove that is configured to provide haptic feedback to a user in association with an artificial-reality application.

FIG. 31 is a block diagram of a microfluidic control system 3100, according to at least one additional embodiment of the present disclosure. In some respects, micro-fluidic control system 3100 may be similar to the micro-fluidic control system 3000 described above with reference to FIG. 30. For example, micro-fluidic control system 3100 of FIG. 31 may be configured to provide programmable fluid pressure (e.g., via air or a liquid) to an array of fluid actuators 3180 (e.g., inflatable bladders, containers, haptic feedback device, artificial-reality glove, etc.). Micro-fluidic control system 3100 may be configured to provide programmable fluid pressure to fluid actuators 3180 in an artificial-reality environment (e.g., artificial-reality environment 3500 of FIG. 35) and/or in association with an artificial-reality system (e.g., vibrotactile system 3400 of FIG. 34).

Micro-fluidic control system 3100 may include a processor 3170 that is configured to provide control signals to piezo valves 3172 (e.g., piezoelectric valves 700 of FIG. 7). Piezo valves 3172 may be configured to selectively provide a high flow rate pressure source and/or pressure drain to a decoder 3174. As shown in FIG. 31, decoder 3174 may provide fluid signals to a fluidic multiplexer 3184. Fluidic multiplexer 3184 may include storage tanks 3186 connected to fluidic select gates (e.g., fluidic valve 500 of FIG. 5, fluidic valve buffer 800 of FIG. 8, etc.). Storage tanks 3186 may hold fluid at a variety of different pressures, such as at low, medium-low, medium, medium-high, and high pressures. The variety of different pressures may be supplied to storage tanks 3186 by digital to analog converter 3176. The fluidic select gates of fluidic multiplexer 3184 may be used to select a pressure level from the storage tanks 3186, such as by passing a fluid from one of the storage tanks 3186 or from a combination of the storage tanks 3186 to one or more multiplexer outlets. Optionally, in some embodiments, the fluidic signal from multiplexer 3185 may be passed to push-pull amplifiers 3178, which may in turn be used to fluidically control fluid actuators 3180. In additional embodiments, push-pull amplifiers 3178 may be omitted and the outlet(s) of multiplexer 3184 may be fluidically coupled to fluid actuators 3180 to control actuation of fluid actuators 3180.

A fluid pressure source 3182 may be configured to provide a pressurized fluid to piezo valves 3172, decoder 3174, digital to analog converter 3076, push-pull amplifiers 3178, and fluid actuators 3180. Piezo valves 3172 may also be configured to drain fluid pressure to a low-pressure drain, such as atmosphere. In some examples, flow inhibitors (e.g., diodes, check valves, etc.) may be coupled to storage tanks 3186 to inhibit a backpressure from flowing into storage tanks 3186 during operation.

The present disclosure includes microfluidic devices, systems, and methods. A single piston fluidic valve may be configured as a logic-gate device for combinatorial and/or sequential digital logic systems. Analog flow regulators and amplifiers may be configured to provide high-flow, variable pressures to actuators, such as inflatable bladders in haptics systems.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

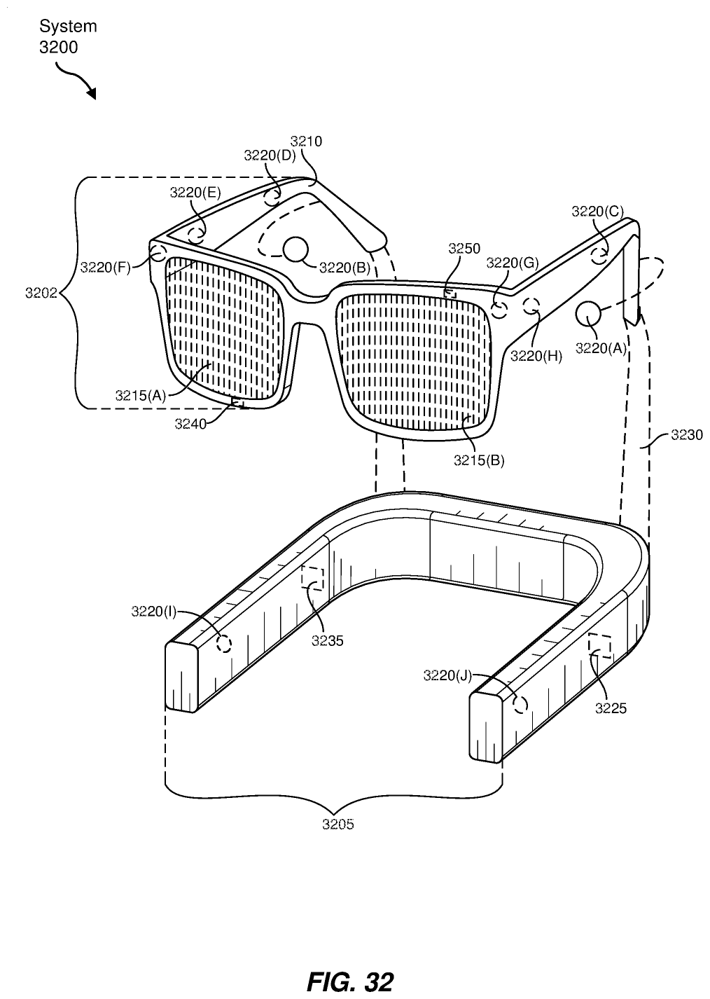

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 3200 in FIG. 32) or that visually immerses a user in an artificial reality (such as, e.g., virtual-reality system 3300 in FIG. 33). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 32, augmented-reality system 3200 may include an eyewear device 3202 with a frame 3210 configured to hold a left display device 3215(A) and a right display device 3215(B) in front of a user's eyes. Display devices 3215(A) and 3215(B) may act together or independently to present an image or series of images to a user. While augmented-reality system 3200 includes two displays, embodiments of this disclosure may be implemented in augmented-reality systems with a single NED or more than two NEDs.

In some embodiments, augmented-reality system 3200 may include one or more sensors, such as sensor 3240. Sensor 3240 may generate measurement signals in response to motion of augmented-reality system 3200 and may be located on substantially any portion of frame 3210. Sensor 3240 may represent one or more of a variety of different sensing mechanisms, such as a position sensor, an inertial measurement unit (IMU), a depth camera assembly, a structured light emitter and/or detector, or any combination thereof. In some embodiments, augmented-reality system 3200 may or may not include sensor 3240 or may include more than one sensor. In embodiments in which sensor 3240 includes an IMU, the IMU may generate calibration data based on measurement signals from sensor 3240. Examples of sensor 3240 may include, without limitation, accelerometers, gyroscopes, magnetometers, other suitable types of sensors that detect motion, sensors used for error correction of the IMU, or some combination thereof.

In some examples, augmented-reality system 3200 may also include a microphone array with a plurality of acoustic transducers 3220(A)-3220(J), referred to collectively as acoustic transducers 3220. Acoustic transducers 3220 may represent transducers that detect air pressure variations induced by sound waves. Each acoustic transducer 3220 may be configured to detect sound and convert the detected sound into an electronic format (e.g., an analog or digital format). The microphone array in FIG. 81220 may include, for example, ten acoustic transducers: 3220(A) and 3220(B), which may be designed to be placed inside a corresponding ear of the user, acoustic transducers 3220(C), 3220(D), 3220(E), 3220(F), 3220(G), and 3220(H), which may be positioned at various locations on frame 3210, and/or acoustic transducers 3220(1) and 3220(J), which may be positioned on a corresponding neckband 3205.

In some embodiments, one or more of acoustic transducers 3220(A)-(F) may be used as output transducers (e.g., speakers). For example, acoustic transducers 3220(A) and/or 3220(B) may be earbuds or any other suitable type of headphone or speaker.

The configuration of acoustic transducers 3220 of the microphone array may vary. While augmented-reality system 3200 is shown in FIG. 32 as having ten acoustic transducers 3220, the number of acoustic transducers 3220 may be greater or less than ten. In some embodiments, using higher numbers of acoustic transducers 3220 may increase the amount of audio information collected and/or the sensitivity and accuracy of the audio information. In contrast, using a lower number of acoustic transducers 3220 may decrease the computing power required by an associated controller 3250 to process the collected audio information. In addition, the position of each acoustic transducer 3220 of the microphone array may vary. For example, the position of an acoustic transducer 3220 may include a defined position on the user, a defined coordinate on frame 3210, an orientation associated with each acoustic transducer 3220, or some combination thereof.

Acoustic transducers 3220(A) and 3220(B) may be positioned on different parts of the user's ear, such as behind the pinna, behind the tragus, and/or within the auricle or fossa. Or, there may be additional acoustic transducers 3220 on or surrounding the ear in addition to acoustic transducers 3220 inside the ear canal. Having an acoustic transducer 3220 positioned next to an ear canal of a user may enable the microphone array to collect information on how sounds arrive at the ear canal. By positioning at least two of acoustic transducers 3220 on either side of a user's head (e.g., as binaural microphones), augmented-reality device 3200 may simulate binaural hearing and capture a 3D stereo sound field around about a user's head. In some embodiments, acoustic transducers 3220(A) and 3220(B) may be connected to augmented-reality system 3200 via a wired connection 3230, and in other embodiments acoustic transducers 3220(A) and 3220(B) may be connected to augmented-reality system 3200 via a wireless connection (e.g., a Bluetooth connection). In still other embodiments, acoustic transducers 3220(A) and 3220(B) may not be used at all in conjunction with augmented-reality system 3200.

Acoustic transducers 3220 on frame 3210 may be positioned in a variety of different ways, including along the length of the temples, across the bridge, above or below display devices 3215(A) and 3215(B), or some combination thereof. Acoustic transducers 3220 may also be oriented such that the microphone array is able to detect sounds in a wide range of directions surrounding the user wearing the augmented-reality system 3200. In some embodiments, an optimization process may be performed during manufacturing of augmented-reality system 3200 to determine relative positioning of each acoustic transducer 3220 in the microphone array.

In some examples, augmented-reality system 3200 may include or be connected to an external device (e.g., a paired device), such as neckband 3205. Neckband 3205 generally represents any type or form of paired device. Thus, the following discussion of neckband 3205 may also apply to various other paired devices, such as charging cases, smart watches, smart phones, wrist bands, other wearable devices, hand-held controllers, tablet computers, laptop computers, other external compute devices, etc.

As shown, neckband 3205 may be coupled to eyewear device 3202 via one or more connectors. The connectors may be wired or wireless and may include electrical and/or non-electrical (e.g., structural) components. In some cases, eyewear device 3202 and neckband 3205 may operate independently without any wired or wireless connection between them. While FIG. 32 illustrates the components of eyewear device 3202 and neckband 3205 in example locations on eyewear device 3202 and neckband 3205, the components may be located elsewhere and/or distributed differently on eyewear device 3202 and/or neckband 3205. In some embodiments, the components of eyewear device 3202 and neckband 3205 may be located on one or more additional peripheral devices paired with eyewear device 3202, neckband 3205, or some combination thereof.

Pairing external devices, such as neckband 3205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 3200 may be provided by a paired device or shared between a paired device and an eyewear device, thus reducing the weight, heat profile, and form factor of the eyewear device overall while still retaining desired functionality. For example, neckband 3205 may allow components that would otherwise be included on an eyewear device to be included in neckband 3205 since users may tolerate a heavier weight load on their shoulders than they would tolerate on their heads. Neckband 3205 may also have a larger surface area over which to diffuse and disperse heat to the ambient environment. Thus, neckband 3205 may allow for greater battery and computation capacity than might otherwise have been possible on a stand-alone eyewear device. Since weight carried in neckband 3205 may be less invasive to a user than weight carried in eyewear device 3202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 3205 may be communicatively coupled with eyewear device 3202 and/or to other devices. These other devices may provide certain functions (e.g., tracking, localizing, depth mapping, processing, storage, etc.) to augmented-reality system 3200. In the embodiment of FIG. 32, neckband 3205 may include two acoustic transducers (e.g., 3220(1) and 3220(J)) that are part of the microphone array (or potentially form their own microphone subarray). Neckband 3205 may also include a controller 3225 and a power source 3235.

Acoustic transducers 3220(1) and 3220(J) of neckband 3205 may be configured to detect sound and convert the detected sound into an electronic format (analog or digital). In the embodiment of FIG. 32, acoustic transducers 3220(1) and 3220(J) may be positioned on neckband 3205, thereby increasing the distance between the neckband acoustic transducers 3220(1) and 3220(J) and other acoustic transducers 3220 positioned on eyewear device 3202. In some cases, increasing the distance between acoustic transducers 3220 of the microphone array may improve the accuracy of beamforming performed via the microphone array. For example, if a sound is detected by acoustic transducers 3220(C) and 3220(D) and the distance between acoustic transducers 3220(C) and 3220(D) is greater than, e.g., the distance between acoustic transducers 3220(D) and 3220(E), the determined source location of the detected sound may be more accurate than if the sound had been detected by acoustic transducers 3220(D) and 3220(E).

Controller 3225 of neckband 3205 may process information generated by the sensors on neckband 3205 and/or augmented-reality system 3200. For example, controller 3225 may process information from the microphone array that describes sounds detected by the microphone array. For each detected sound, controller 3225 may perform a direction-of-arrival (DOA) estimation to estimate a direction from which the detected sound arrived at the microphone array. As the microphone array detects sounds, controller 3225 may populate an audio data set with the information. In embodiments in which augmented-reality system 3200 includes an inertial measurement unit, controller 3225 may compute all inertial and spatial calculations from the IMU located on eyewear device 3202. A connector may convey information between augmented-reality system 3200 and neckband 3205 and between augmented-reality system 3200 and controller 3225. The information may be in the form of optical data, electrical data, wireless data, or any other transmittable data form. Moving the processing of information generated by augmented-reality system 3200 to neckband 3205 may reduce weight and heat in eyewear device 3202, making it more comfortable to the user.

Power source 3235 in neckband 3205 may provide power to eyewear device 3202 and/or to neckband 3205. Power source 3235 may include, without limitation, lithium ion batteries, lithium-polymer batteries, primary lithium batteries, alkaline batteries, or any other form of power storage. In some cases, power source 3235 may be a wired power source. Including power source 3235 on neckband 3205 instead of on eyewear device 3202 may help better distribute the weight and heat generated by power source 3235.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 3300 in FIG. 33, that mostly or completely covers a user's field of view. Virtual-reality system 3300 may include a front rigid body 3302 and a band 3304 shaped to fit around a user's head. Virtual-reality system 3300 may also include output audio transducers 3306(A) and 3306(B). Furthermore, while not shown in FIG. 33, front rigid body 3302 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 3200 and/or virtual-reality system 3300 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some the artificial-reality systems described herein may include one or more projection systems. For example, display devices in augmented-reality system 3200 and/or virtual-reality system 3300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 3200 and/or virtual-reality system 3300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including WiFi, Bluetooth, global positioning system (GPS), cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented-reality and virtual-reality devices may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented-reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial-reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some embodiments, an artificial-reality device may implement one or more microphones to listen to sounds within the user's environment. The augmented-reality or virtual-reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

As noted, artificial-reality systems 3200 and 3300 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 34 illustrates a vibrotactile system 3400 in the form of a wearable glove (haptic device 3410) and wristband (haptic device 3420). Haptic device 3410 and haptic device 3420 are shown as examples of wearable devices that include a flexible, wearable textile material 3430 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 3440 may be positioned at least partially within one or more corresponding pockets formed in textile material 3430 of vibrotactile system 3400. Vibrotactile devices 3440 may be positioned in locations to provide a vibrating sensation (e.g., haptic feedback) to a user of vibrotactile system 3400. For example, vibrotactile devices 3440 may be positioned against the user's finger(s), thumb, or wrist, as shown in FIG. 34. Vibrotactile devices 3440 may, in some examples, be sufficiently flexible to conform to or bend with the user's corresponding body part(s).

A power source 3450 (e.g., a battery) for applying a voltage to the vibrotactile devices 3440 for activation thereof may be electrically coupled to vibrotactile devices 3440, such as via conductive wiring 3452. In some examples, each of vibrotactile devices 3440 may be independently electrically coupled to power source 3450 for individual activation. In some embodiments, a processor 3460 may be operatively coupled to power source 3450 and configured (e.g., programmed) to control activation of vibrotactile devices 3440.

Vibrotactile system 3400 may be implemented in a variety of ways. In some examples, vibrotactile system 3400 may be a standalone system with integral subsystems and components for operation independent of other devices and systems. As another example, vibrotactile system 3400 may be configured for interaction with another device or system 3470. For example, vibrotactile system 3400 may, in some examples, include a communications interface 3480 for receiving and/or sending signals to the other device or system 3470. The other device or system 3470 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 3480 may enable communications between vibrotactile system 3400 and the other device or system 3470 via a wireless (e.g., Wi-Fi, Bluetooth, cellular, radio, etc.) link or a wired link. If present, communications interface 3480 may be in communication with processor 3460, such as to provide a signal to processor 3460 to activate or deactivate one or more of the vibrotactile devices 3440.

Vibrotactile system 3400 may optionally include other subsystems and components, such as touch-sensitive pads 3490, pressure sensors, motion sensors, position sensors, lighting elements, and/or user interface elements (e.g., an on/off button, a vibration control element, etc.). During use, vibrotactile devices 3440 may be configured to be activated for a variety of different reasons, such as in response to the user's interaction with user interface elements, a signal from the motion or position sensors, a signal from the touch-sensitive pads 3490, a signal from the pressure sensors, a signal from the other device or system 3470, etc.

Although power source 3450, processor 3460, and communications interface 3480 are illustrated in FIG. 34 as being positioned in haptic device 3420, the present disclosure is not so limited. For example, one or more of power source 3450, processor 3460, or communications interface 3480 may be positioned within haptic device 3410 or within another wearable textile.

Haptic wearables, such as those shown in and described in connection with FIG. 34, may be implemented in a variety of types of artificial-reality systems and environments. FIG. 35 shows an example artificial-reality environment 3500 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 3502 generally represents any type or form of virtual-reality system, such as virtual-reality system 3300 in FIG. 33. Head-mounted display 3502 may include an adjustable strap system 1105 shaped to fit around a user's head. Haptic device 3504 generally represents any type or form of wearable device, worn by a user of an artificial-reality system, that provides haptic feedback to the user to give the user the perception that he or she is physically engaging with a virtual object. In some embodiments, haptic device 3504 may provide haptic feedback by applying vibration, motion, and/or force to the user. For example, haptic device 3504 may limit or augment a user's movement. To give a specific example, haptic device 3504 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 3504 to send action requests to a console. Examples of action requests include, without limitation, requests to start an application and/or end the application and/or requests to perform a particular action within the application.

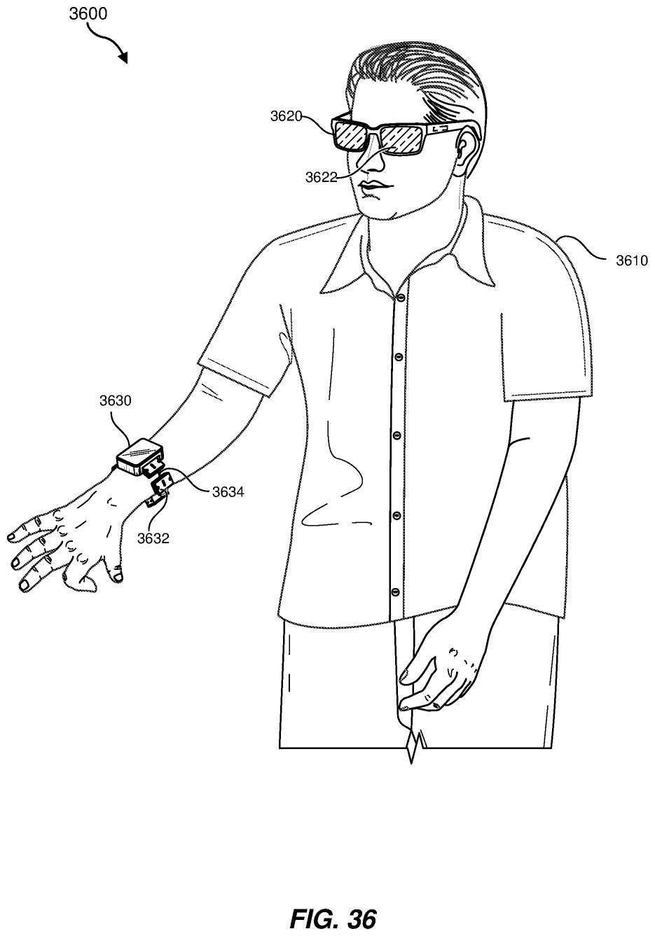

While haptic interfaces may be used with virtual-reality systems, as shown in FIG. 35, haptic interfaces may also be used with augmented-reality systems, as shown in FIG. 36. FIG. 36 is a perspective view of a user 3610 interacting with an augmented-reality system 3600. In this example, user 3610 may wear a pair of augmented-reality glasses 3620 that may have one or more displays 3622 and that are paired with a haptic device 3630. In this example, haptic device 3630 may be a wristband that includes a plurality of band elements 3632 and a tensioning mechanism 3634 that connects band elements 3632 to one another.

One or more of band elements 3632 may include any type or form of actuator suitable for providing haptic feedback. For example, one or more of band elements 3632 may be configured to provide one or more of various types of cutaneous feedback, including vibration, force, traction, texture, and/or temperature. To provide such feedback, band elements 3632 may include one or more of various types of actuators. In one example, each of band elements 3632 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 3410, 3420, 3504, and 3630 may include any suitable number and/or type of haptic transducer, sensor, and/or feedback mechanism. For example, haptic devices 3410, 3420, 3504, and 3630 may include one or more mechanical transducers, piezoelectric transducers, and/or fluidic transducers. Haptic devices 3410, 3420, 3504, and 3630 may also include various combinations of different types and forms of transducers that work together or independently to enhance a user's artificial-reality experience. In one example, each of band elements 3632 of haptic device 3630 may include a vibrotactor (e.g., a vibrotactile actuator) configured to vibrate in unison or independently to provide one or more of various types of haptic sensations to a user.

By way of non-limiting examples, the following embodiments are included in the present disclosure.

Example 1: A microfluidic device may include a first inlet port configured to convey a first fluid exhibiting a first pressure into the fluidic device, a second inlet port configured to convey a second fluid exhibiting a second pressure into the fluidic device, an output port that is configured to convey one of the first fluid or the second fluid out of the fluidic device, and a piston that is movable between a first position that inhibits fluid flow through the second inlet port to the output port and a second position that inhibits fluid flow through the first inlet port to the output port, wherein movement of the piston between the first and second positions is determined by control pressure applied against a control gate of the piston, wherein a flange of the piston has an outer diameter of about 10 mm or less.

Example 2: The microfluidic device of Example 1, wherein the first fluid and the second fluid comprise at least one of a gas, air, or a liquid.

Example 3: The microfluidic device of Example 1 or Example 2, wherein the piston comprises at least one of rubber, polymer, nitrile, or silicone.

Example 4: The microfluidic device of any of Examples 1 through 3, wherein the piston is configured in at least one of a biased down configuration, a biased up configuration, a biased center configuration, or a high gain configuration.

Example 5: The microfluidic device of any of Examples 1 through 4, wherein the first inlet port, the second inlet port, and the gate provide fluidic input signals and a fluidic output signal is provided at the outlet port, and wherein the microfluidic device is configured as at least one of the following: a buffer, an inverter, an OR gate, or an AND gate.

Example 6: The microfluidic device of any of Examples 1 through 5, wherein the microfluidic device comprises a plurality of microfluidic devices and the plurality of microfluidic devices are configured as at least one of: a demultiplexer, a full adder, a row-column buffered latch decoder, a row-column demultiplexer, a row-column inverted latch decoder, or a row-column inverted demultiplexer.

Example 7: The microfluidic device of any of Examples 1 through 6, wherein the microfluidic device comprises a first fluidic device and a second fluidic device configured as at least one of: a NOR gate, a NAND gate, an XOR gate, or an XNOR gate.

Example 8: The microfluidic device of any of Examples 1 through 7, wherein the microfluidic device comprises a first fluidic device and a second fluidic device that are together configured as an XOR gate, the first fluidic device comprises: a first source port, a first drain port, a first gate port, a first output, and a first valve element for switching flow from the first source port between the first drain port and the first output, the second fluidic device comprises: a second source port, a second drain port, a second gate port, a second output, and a second valve element for switching flow from the second source port between the second drain port and the second output the first source port is connected to a high-pressure source, the first drain port is connected to a low-pressure source, the first output is connected to the second drain port, the first gate port is connected to the second source port, when the high-pressure source is connected to the first gate port or the second gate port, the high-pressure source is connected to the second output, and when the high-pressure source is connected to the first gate port and the second gate port or the low-pressure source is connected to the first gate port and the second gate port, the low-pressure source is connected to the second output.

Example 9: The microfluidic device of any of Examples 1 through 8, wherein at least one of the first fluid or the second fluid is supplied from a piezoelectric valve.

Example 10: The microfluidic device of Example 9, wherein the piezoelectric valve comprises first and second piezoelectric actuators configured as cantilevered beams wherein the first piezoelectric actuator is configured to control flow of one of the first fluid or the second fluid through a source port, the second piezoelectric actuator is configured to control flow of one of the first fluid or the second fluid through a drain port, and the first and second piezoelectric actuators are configured to be simultaneously actuated in a same direction.

Example 11: The microfluidic device of Example 9, wherein the piezoelectric valve is configured to be electrically actuated and provide an interface between an electronic control system and the microfluidic device.

Example 12: The microfluidic device of any of Examples 1 through 11, wherein the microfluidic device is configured to convey at least one of the first fluid or the second fluid to a fluid chamber.

Example 13: The microfluidic device of any of Examples 1 through 12, wherein the microfluidic device comprises a first fluidic device and a second fluidic device and the first fluidic device and the second fluidic device are configured as a push-pull fluid amplifier.

Example 14: The microfluidic device of Example 13, wherein a base port of the first fluidic device is connected to a pressure source, a base port of the second fluidic device is connected to a pressure drain, an output port of the first fluidic device is connected to a fluid chamber, an output port of the second fluidic device is connected to the fluid chamber, a gate port of the first fluidic device is connected to a variable pressure input, a gate port of the second fluidic device is connected to the variable pressure input, and the fluidic device is configured to mirror the variable pressure input in the fluid chamber.

Example 15: The microfluidic device of Example 14, wherein a fluid flow rate in the fluid chamber is higher than a fluid flow rate in the gate port of the first fluidic device and the gate port of the second fluidic device.

Example 16: The microfluidic device of Example 14, wherein the variable pressure input is provided by a linearized variable pressure regulator device.

Example 17: The microfluidic device of any of Examples 1 through 16, wherein at least one of the first inlet port or the second inlet port is connected to a linearized variable pressure regulator device, the linearized variable pressure regulator device comprises a plurality of flow restrictors, each of the flow restrictors comprises a different diameter orifice, and the plurality of flow restrictors are configured to create the linearized variable pressure regulator device.

Example 18: The microfluidic device of any of Examples 1 through 17, wherein the microfluidic device is configured to control a flow of fluid to a bladder in a glove and the bladder in the glove is configured to provide haptic feedback to a user in association with an artificial-reality application.

Example 19: A fluidic logic-gate device, comprising an input port, n select ports, a drive input port, 2n output ports, 2n control gates respectively coupled to the output ports, fluid channels configured to route fluid from the input port to the control gates, and select pistons each comprising a gate element fluidically coupled to one of the select ports and configured to, when at a first pressure state, block a first one of the fluid channels and unblock a second one of the fluid channels, and, when at a second pressure state, unblock the first one of the fluid channels and block the second one of the fluid channels, wherein each combination of the first pressure state and the second pressure state on the select ports opens a unique fluid route from the input port to a selected one of the control gates to transmit a state of the drive input port to a respective output port.

Example 20: A binary fluidic full-adder device, comprising a first XOR fluidic device configured to produce a logical exclusive OR of a first and second binary fluidic input at a first output, a second XOR fluidic device configured to produce a logical exclusive OR of the first output and a carry-in binary fluidic input at a second output representative of an arithmetic sum of the first, second, and carry-in binary fluidic inputs, a first AND fluidic device configured to produce a logical AND of the first output and the carry binary fluidic input at a third output, a second AND fluidic device configured to produce a logical AND of the first and second binary fluidic inputs at a fourth output, and an OR fluidic device configured to produce a logical OR of the third and fourth output at a fifth output representative of an arithmetic carry of the first, second, and carry-in binary fluidic inputs.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A microfluidic device comprising:
a first inlet port configured to convey a first fluid exhibiting a first pressure into the fluidic device;
a second inlet port configured to convey a second fluid exhibiting a second pressure into the fluidic device;
an output port that is configured to convey one of the first fluid or the second fluid out of the fluidic device; and
a piston that is movable between a first position that inhibits fluid flow through the second inlet port to the output port and a second position that inhibits fluid flow through the first inlet port to the output port, wherein movement of the piston between the first and second positions is determined by control pressure applied against a control gate of the piston, wherein a flange of the piston has an outer diameter of about 10 mm or less.

2. The microfluidic device of claim 1, wherein the first fluid and the second fluid comprise at least one of a gas, air, or a liquid.

3. The microfluidic device of claim 1, wherein the piston comprises at least one of rubber, a polymer, nitrile, or silicone.

4. The microfluidic device of claim 1, wherein the piston is configured in at least one of:
a biased down configuration;
a biased up configuration;
a biased center configuration; or
a high gain configuration.

5. The microfluidic device of claim 1, wherein the first inlet port, the second inlet port, and the gate provide fluidic input signals and a fluidic output signal is provided at the outlet port, and wherein the microfluidic device is configured as at least one of the following:
a buffer;
an inverter;
an OR gate; or
an AND gate.

6. The microfluidic device of claim 1, wherein the microfluidic device comprises a plurality of microfluidic devices and the plurality of microfluidic devices are configured as at least one of:
a demultiplexer;
a full adder;
a row-column buffered latch decoder;
a row-column demultiplexer;
a row-column inverted latch decoder; or
a row-column inverted demultiplexer.

7. The microfluidic device of claim 1, wherein the microfluidic device comprises a first fluidic device and a second fluidic device configured as at least one of:
a NOR gate;
a NAND gate;
an XOR gate; or
an XNOR gate.

8. The microfluidic device of claim 1, wherein:
the microfluidic device comprises a first fluidic device and a second fluidic device that are together configured as an XOR gate;
the first fluidic device comprises:
a first source port;
a first drain port;
a first gate port;
a first output; and
a first valve element for switching flow from the first source port between the first drain port and the first output; and
the second fluidic device comprises:
a second source port;
a second drain port;
a second gate port;
a second output; and
a second valve element for switching flow from the second source port between the second drain port and the second output;
the first source port is connected to a high-pressure source;
the first drain port is connected to a low-pressure source;
the first output is connected to the second drain port;
the first gate port is connected to the second source port;
when the high-pressure source is connected to the first gate port or the second gate port, the high-pressure source is connected to the second output; and
when the high-pressure source is connected to the first gate port and the second gate port or the low-pressure source is connected to the first gate port and the second gate port, the low-pressure source is connected to the second output.

9. The microfluidic device of claim 1, wherein at least one of the first fluid or the second fluid is supplied from a peizoelectric valve.

10. The microfluidic device of claim 9, wherein the peizoelectric valve comprises first and second peizoelectric actuators configured as cantilevered beams wherein:
the first peizoelectric actuator is configured to control flow of one of the first fluid or the second fluid through a source port;
the second peizoelectric actuator is configured to control flow of one of the first fluid or the second fluid through a drain port; and
the first and second peizoelectric actuators are configured to be simultaneously actuated in a same direction.

11. The microfluidic device of claim 9, wherein the peizoelectric valve is configured to:
be electrically actuated; and
provide an interface between an electronic control system and the microfluidic device.

12. The microfluidic device of claim 1, wherein the microfluidic device is configured to convey at least one of the first fluid or the second fluid to a fluid chamber.

13. The microfluidic device of claim 1, wherein:
the microfluidic device comprises a first fluidic device and a second fluidic device; and
the first fluidic device and the second fluidic device are configured as a push-pull fluid amplifier.

14. The microfluidic device of claim 13, wherein:
a base port of the first fluidic device is connected to a pressure source;
a base port of the second fluidic device is connected to a pressure drain;
an output port of the first fluidic device is connected to a fluid chamber;
an output port of the second fluidic device is connected to the fluid chamber;
a gate port of the first fluidic device is connected to a variable pressure input;
a gate port of the second fluidic device is connected to the variable pressure input; and
the fluidic device is configured to mirror the variable pressure input in the fluid chamber.

15. The microfluidic device of claim 14, wherein a fluid flow rate in the fluid chamber is higher than a fluid flow rate in the gate port of the first fluidic device and the gate port of the second fluidic device.

16. The microfluidic device of claim 14, wherein the variable pressure input is provided by a linearized variable pressure regulator device.

17. The microfluidic device of claim 1, wherein:
at least one of the first inlet port or the second inlet port is connected to a linearized variable pressure regulator device;
the linearized variable pressure regulator device comprises a plurality of flow restrictors;
each of the flow restrictors comprises a different diameter orifice; and
the plurality of flow restrictors are configured to create the linearized variable pressure regulator device.

18. The microfluidic device of claim 1, wherein:
the microfluidic device is configured to control a flow of fluid to an inflatable bladder in a glove; and
the bladder in the glove is configured to provide haptic feedback to a user in association with an artificial-reality application.

19. A fluidic logic-gate device, comprising:
an input port;
n select ports;
a drive input port;
2ⁿ output ports;
2ⁿ control gates respectively coupled to the output ports;
fluid channels configured to route fluid from the input port to the control gates; and
select pistons each comprising a gate element fluidically coupled to one of the select ports and configured to, when at a first pressure state, block a first one of the fluid channels and unblock a second one of the fluid channels, and, when at a second pressure state, unblock the first one of the fluid channels and block the second one of the fluid channels, wherein each combination of the first pressure state and the second pressure state on the select ports opens a unique fluid route from the input port to a selected one of the control gates to transmit a state of the drive input port to a respective output port.

20. A binary fluidic full-adder device, comprising:
a first XOR fluidic device configured to produce a logical exclusive OR of a first and second binary fluidic input at a first output;
a second XOR fluidic device configured to produce a logical exclusive OR of the first output and a carry-in binary fluidic input at a second output representative of an arithmetic sum of the first, second, and carry-in binary fluidic inputs;
a first AND fluidic device configured to produce a logical AND of the first output and the carry binary fluidic input at a third output;
a second AND fluidic device configured to produce a logical AND of the first and second binary fluidic inputs at a fourth output; and
an OR fluidic device configured to produce a logical OR of the third and fourth output at a fifth output representative of an arithmetic carry of the first, second, and carry-in binary fluidic inputs.
